(19) United States
(12) Patent Application Publication
(10) Pub. No.: US 2026/0070297 A1
(43) Pub. Date: Mar. 12, 2026

(54) SYSTEMS AND METHODS FOR DISPENSING AND EXPANDING EXPANDABLE SLIT SHEET MATERIAL

(71) Applicant: David Paul Goodrich, Sedona, AZ (US)

(72) Inventor: David Paul Goodrich, Sedona, AZ (US)

(21) Appl. No.: 19/273,431

(22) Filed: Jul. 18, 2025

Related U.S. Application Data
(60) Provisional application No. 63/673,146, filed on Jul. 18, 2024.

(51) Int. Cl. B31D 5/00; B65H 16/00; B65H 16/06; B65H 19/12; B65H 23/08

(52) U.S. Cl. CPC B31D 5/0065; B65H 16/005; B65H 16/06; B65H 19/126; B65H 23/08; B65H 2301/41346; B65H 2402/54; B65H 2403/7251

(57) ABSTRACT

According to some embodiments, a system for dispensing and manually expanding expandable slit sheet material is provided that includes: a roll of expandable slit sheet material, the roll of expandable slit sheet material being wound around a tubular core, a frame having a first support wall, a second support wall, and at least one connecting member extending between the first support wall and the second support wall, the first support wall having a first core support fixedly attached thereto that extends inwardly on an interior side of the first support wall, the first core support having a curved support surface that is configured to be received within a first open end of the core, the second support wall having a second core support fixedly attached thereto that extends inwardly on an interior side of the second support wall, the first core support having a curved support surface that is configured to be received within a first open end of the core, the first support wall having a tensioner including a) a handle member, b) a pressure member having a curved pressure surface configured to be received within the first open end of the core proximate the first core support, and c) a spring positioned to apply pressure against the pressure member upon movement of the handle, and wherein at least one of the first core support and the second core support are movable to enable the roll of expandable slit sheet material wound around the tubular core to be lowered upon the frame and the first core support and the second core support to be received within the core.

The present application is a non-provisional of U.S. Patent Application Ser. No. 63/673,146, filed Jul. 18, 2024, entitled Improved Systems and Methods for Dispensing And Expanding Expandable Slit Sheet Material, the entire disclosure of which is incorporated herein by reference.

### BACKGROUND

The preferred embodiments of the present invention relate to dispensers for dispensing expandable slit sheet material.

The present application further improves upon the present inventor's prior manual dispensers for expandable slit-sheet material shown in the following patents and patent publications, the entire disclosures of each of which patents and patent publications are incorporated herein by reference in their entireties:
1) U.S. Patent Publication No. 2021/0315426 (U.S. Ser. No. 17/230,682), filed Apr. 25, 2021, to Goodrich;
2) U.S. Patent Publication No. 2019/0248092 (U.S. Ser. No. 16/397,503), filed Apr. 29, 2019, to Goodrich;
3) U.S. Pat. No.
4) U.S. Pat. No. 11,220,395, filed Nov. 22, 2017, to Goodrich;
5) U.S. Pat. No. 11,608,222, filed Feb. 8, 2017, to Goodrich; and
6) U.S. Pat. No. 11,479,009, filed Mar. 1, 2019, to Goodrich.

Further information relating to illustrative paper that can be employed in embodiments of the present invention, illustrative slit patterns for such expandable slit sheet material, and illustrative manual expansion processing of expandable slit sheet material is found in U.S. patents and U.S. Patent Publications: U.S. Pat. Nos. 5,538,778; 5,667,871; 5,688,578; and 5,782,735; 3,908,071; 3,104,197; 3,220,116; 3,266,972; 3,269,393; 3,908,071; 6,024,832; 6,458,447; 6,712,930; US2002/0060034; and 2007/0240841, the disclosures of which U.S. patents and U.S. Patent Publications are all incorporated herein by reference in their entireties.

### SUMMARY OF THE PREFERRED EMBODIMENTS

The preferred embodiments of the present invention provide improvements over the technologies in the above and/or other background art. The following numbered examples set forth some preferred embodiments of the present invention.

1. According to some preferred embodiments of the invention, a system for dispensing and manually expanding expandable slit sheet material is provided that includes:
a roll of expandable slit sheet material, said roll of expandable slit sheet material being wound around a tubular core,
a frame having a first support wall, a second support wall, and at least one connecting member extending between the first support wall and the second support wall,
said first support wall having a first core support fixedly attached thereto that extends inwardly on an interior side of the first support wall, said first core support having a curved support surface that is configured to be received within a first open end of the core,
said second support wall having a second core support fixedly attached thereto that extends inwardly on an interior side of the second support wall, said first core support having a curved support surface that is configured to be received within a first open end of the core,
said first support wall having a tensioner including a) a handle member, b) a pressure member having a curved pressure surface configured to be received within the first open end of the core proximate said first core support, and c) a spring positioned to apply pressure against said pressure member upon movement of said handle, and
wherein at least one of said first core support and said second core support are movable to enable the roll of expandable slit sheet material wound around said tubular core to be lowered upon said frame and said first core support and said second core support to be received within said core.

2. In some further embodiments, the system of the above example 1 further includes wherein said handle is a rotary member that is manually rotated.

3. In some further embodiments, the system of the above example 2 further includes wherein said spring is a coil spring that is compressed upon rotation of said rotary member.

4. In some further embodiments, the system of any of the above examples further includes wherein said expandable slit sheet material is an expandable slit sheet paper.

5. In some further embodiments, the system of the above example 4 further includes wherein said expandable slit sheet paper is an entirely recyclable paper.

6. In some further embodiments, the system of any of the preceding examples further includes wherein said core is made from paper, paperboard or cardboard.

7. In some further embodiments, the system of the above example 6 further includes wherein said core is entirely recyclable.

8. In some further embodiments, the system of the above example 1 further includes wherein said second core support is a ball member.

9. In some further embodiments, the system of any of the above examples 2-8 further includes wherein said second core support is a ball member.

10. In some further embodiments, the system of the above example 1 further includes wherein said second core support is movably mounted on said second support wall.

11. In some further embodiments, the system of any of the above examples 2-9 further includes wherein said second core support is movably mounted on said second support wall.

12. In some further embodiments, the system of the above example 10 further includes wherein said second core support is biased with a spring.

13. In some further embodiments, the system of the above example 11 further includes wherein said second core support is biased with a spring.

14. In some further embodiments, the system of the above example 1 further includes wherein said second core support is hingedly supported on said second support wall.

15. In some further embodiments, the system of any of the above examples 2-9 further include wherein said second core support is hingedly supported on said second support wall.

16. In some further embodiments, the system of the above example 14 further includes wherein said second core support is biased with a spring.

17. In some further embodiments, the system of the above example 15 further includes wherein said second core support is biased with a spring.

18. According to some other preferred embodiments of the invention, a method of manually expanding expandable slit sheet material from a manual dispenser is performed that includes:
a) providing a roll of expandable slit sheet material wound around a tubular core;
b) providing a manual dispenser having a frame including i) a first core support having a support surface that is configured to be received within a first open end of the tubular core and ii) a second core support having a support surface that is configured to be received within a second open end of the tubular core,
b) moving at least one of said first core support or said second core support such that a distance between an innermost end of said first core support and an innermost end of said second core support is greater than a length of said tubular core,
c) lowering said roll of expandable slit sheet material wound around the tubular core upon said frame,
d) moving at least one of said first core support or said second core support such that i) the distance between the innermost end of said first core support and the innermost end of said second core support is less than the length of said tubular core and ii) said first core support is received within said first open end of said tubular core and said second core support is received within said second open end of said tubular core.

19. In some further embodiments, the method of the above example 18 further includes applying a tension inhibiting rotation of the roll using a tensioner support on said frame that presses a pressure member against an interior of said core.

20. In some further embodiments, the method of the above example 19 further includes wherein said applying tension includes providing a manual tensioner that includes a) a handle member, b) a pressure member having a curved pressure surface configured to be received within the first open end of the core proximate said first core support, and c) a spring positioned to apply pressure against said pressure member upon movement of said handle.

21. In some further embodiments, the method of the above example 20 further includes wherein said handle member is a rotary member that is manually rotated.

22. In some further embodiments, the method of the above example 21 further includes wherein said spring is a coil spring that is compressed upon rotation of said rotary member.

23. In some further embodiments, the method of any of the above examples 18-22 further includes wherein said expandable slit sheet material is an expandable slit sheet paper.

24. In some further embodiments, the method of the above example 23 further includes wherein said expandable slit sheet paper is an entirely recyclable paper.

25. In some further embodiments, the method of any of the above examples 18-22 further includes wherein said core is made from paper, paperboard or cardboard.

26. In some further embodiments, the method of the above example 25 further includes wherein said core is entirely recyclable.

27. In some further embodiments, the method of the above example 18 further includes wherein said second core support is a ball member.

28. In some further embodiments, the method of any of the above examples 19-22 further includes wherein said second core support is a ball member.

29. In some further embodiments, the method of the above example 18 further includes wherein said second core support is mounted on a member that is movably connected to said second support wall.

30. In some further embodiments, the method of any of the above examples 19-22 further includes wherein said second core support is mounted on a member that is movably connected to said second support wall.

31. In some further embodiments, the method of any of the above examples 18-30 further include wherein said first core support has a curved support surface configured to contact an interior surface of said core, and wherein said second core support has a curved support surface configured to contact an interior surface of said core.

32. According to some other preferred embodiments of the present invention, a system for manually expanding expandable slit sheet material is provided that includes:
a) a roll of expandable slit sheet material wound around a tubular core;
b) a manual dispenser having a frame including i) a first core support having a support surface that is configured to be received within a first open end of the tubular core and ii) a second core support having a support surface that is configured to be received within a second open end of the tubular core,
b) at least one of said first core support and said second core support being movably mounted on said frame such that a distance between the innermost end of said first core support and the innermost end of said second core support is changeable between a) a first position in which a distance between an innermost end of said first core support and an innermost end of said second core support is greater than a length of said tubular core whereby the roll of expandable material wound around the tubular core can be lowered upon said frame in between said innermost end of said first core support and said innermost end of said second core support and b) a second position in which the distance between the innermost end of said first core support and the innermost end of said second core support is less than a length of said tubular core and said first core support is received within said first open end of said tubular core and said second core support is received within said second open end of said tubular core.

33. In some further embodiments, the system of the above example 32 further includes wherein said first core support has a curved support surface configured to contact an interior surface of said core, and wherein said second core support has a curved support surface configured to contact an interior surface of said core.

34. In some further embodiments, the system of any of the above examples 32 to 33 further includes a tensioner supported on said frame that presses a pressure member against an interior of said core.

35. In some further embodiments, the system of any of the above examples 32 to 33 further includes a tensioner that includes a) a handle member, b) a pressure member having a curved pressure surface configured to be received within the first open end of the core proximate said first core support, and c) a spring positioned to apply pressure against said pressure member upon movement of said handle.

36. In some further embodiments, the system of the above example 35 further includes wherein said handle member is a rotary member that is manually rotated.

37. In some further embodiments, the system of the above example 36 further includes wherein said spring is a coil spring that is compressed upon rotation of said rotary member.

38. In some further embodiments, the system of any of the above examples 32-37 further includes wherein said expandable slit sheet material is an expandable slit sheet paper.

39. In some further embodiments, the system of the above example 38 further includes wherein said expandable slit sheet paper is an entirely recyclable paper.

40. In some further embodiments, the system of any of the above examples 33-37 further includes wherein said core is made from paper, paperboard or cardboard.

41. In some further embodiments, the system of the above example 40 further includes wherein said core is entirely recyclable.

42. In some further embodiments, the system of any of the above examples 33-37 further includes wherein said second core support is a ball member.

43. In some further embodiments, the system of any of the above examples 33-37 further includes wherein said second core support is mounted on a member that is movably connected to said second support wall.

44. According to some further embodiments, a system for dispensing and manually expanding expandable slit sheet paper is provided that includes:
a roll of expandable slit sheet paper, said roll of expandable slit sheet paper being wound around a tubular core,
a frame having a first support wall,
a first core support fixedly attached to the first support wall and extending inwardly on an interior side of the first support wall, said first core support having a curved support surface that is configured to be received within a first open end of the core,
said first support wall having a tensioner including a) a handle member, b) a pressure member having a length that extends from an exterior of the tubular core into an interior of the tubular core, and c) a spring positioned to apply pressure against said pressure member upon movement of said handle member, and
said pressure member applying pressure upon a cylindrical interior surface of the tubular core via a curved pressure surface.

45. In some further embodiments, the system of example 44 further includes wherein said handle member is a rotated member.

46. In some further embodiments, the system of any of examples 44-45 further include wherein said tubular core has a length of between about 10 to 25 inches and wherein said curved pressure surface contacts the cylindrical interior surface of the tubular core between about ½ inch and 4 inches from an end of the tubular core.

47. In some further embodiments, the system of any of examples 44-46 further include wherein said curved pressure surface contacts the cylindrical interior surface of the tubular core between about 1 inch and 3 inches from an end of the tubular core.

48. In some further embodiments, the system of any of examples 44-47 further include wherein said tubular core has a length of between about 10 to 25 inches and said curved pressure surface contacts the cylindrical interior surface of the tubular core only within a range of between about ½ inch and 4 inches from an end of the tubular core.

49. In some further embodiments, the system of any of examples 44-48 further include wherein said curved pressure surface contacts the cylindrical interior surface of the tubular core only within a range of between about 1 inch and 3 inches from an end of the tubular core.

50. In some further embodiments, the system of any of examples 44-49 further include wherein said curved pressure surface is located beneath said curved support surface of said first core support.

51. In some further embodiments, the system of any of examples 44-50 further include wherein said curved pressure surface presses downloadly upon a bottom interior surface of the interior of the tubular core.

52. In some further embodiments, the system of any of examples 44-51 further include wherein said curved support surface extends entirely across the length of the tubular core.

53. In some further embodiments, the system of example 52 further includes wherein said curved support surface is a surface of a support shaft.

54. In some further embodiments, the system of any of examples 44-51 further includes wherein said curved support surface extends partially across the length of the tubular core.

55. In some further embodiments, the system of example 54 further includes wherein said curved support surface extends between about ½ inch and 5 inches across the length of the tubular core.

56. In some further embodiments, the system of example 55 further includes wherein said curved support surface extends greater than 1 inch within the length of the tubular core.

57. In some further embodiments, the system of example 55 further includes wherein said curved support surface extends less than 4 inches within the length of the tubular core.

58. In some further embodiments, the system of any of examples 44-57 further include wherein said handle member is a rotary member that is manually rotated.

59. In some further embodiments, the system of example 58 further includes wherein said spring is a coil spring that is compressed upon rotation of said rotary member.

60. In some further embodiments, the system of any of examples 44-59 further include wherein said tubular core is made from paper, paperboard or cardboard.

61. In some further embodiments, the system of any of examples 44-60 further include wherein said curved pressure surface is a surface of said pressure member or an element directly or indirectly pressed by said pressure member.

62. In some further embodiments, the system of example 61 further includes wherein said curved pressure surface is a surface of said pressure member.

63. In some further embodiments, the system of any of examples 44-62 further include wherein said pressure member is a lever arm.

64. In some further embodiments, the system of example 63 further includes wherein said lever arm is a movable elongated member that extends from the exterior of the tubular core into the interior of the tubular core.

65. In some further embodiments, the system of example 63 further includes wherein said lever arm is movable transverse to its length to apply a levered pressure force.

66. In some further embodiments, the system of any of examples 61-65 further include wherein said lever arm is reciprocated.

67. In some further embodiments, the system of example 66 further includes wherein said lever arm is reciprocated substantially linearly.

68. In some further embodiments, the system of any of examples 61-67 further include wherein said lever arm is reciprocated in a direction transverse to a length of the tubular core.

69. In some further embodiments, the system of any of examples 61-68 further include wherein said lever arm is reciprocated in a vertical direction

70. In some further embodiments, the system of any of examples 61-69 further include wherein said lever arm is reciprocated in a vertical direction on an exterior side of said support wall.

71. In some further embodiments, the system of any of examples 61-70 further include wherein said lever arm is reciprocated in a vertical direction on an exterior side of said support wall and on an interior side of said support wall.

72. In some further embodiments, the system of example 71 further includes wherein said lever arm is concurrently reciprocated in the same direction on the exterior side of said support wall and the interior side of said support wall, and, in some other further embodiments, the system of example 71 further includes wherein said lever arm is concurrently reciprocated in opposite directions on the exterior side of said support wall and the interior side of said support wall, and, in some implementations, wherein the lever arm is concurrently reciprocated in opposite directions on the exterior side of said support wall and the interior side of said support wall by pivoting the lever arm upon said support wall.

In some implementations of the various embodiments, the expandable slit sheet material is made with an extensible paper. In some examples, said extensible paper has an extensibility in a machine direction of greater than 3%. In some examples, said extensible paper has an extensibility of between about 3-20% in a machine direction. In some examples, said extensible paper has an extensibility of between about 3-9% in a machine direction.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect(s) or feature(s) of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are described by a way of example, and not limitation, in relation to the accompanying figures, in which:

FIGS. 1-4 show an illustrative dispenser for manually dispensing expandable slit sheet material according to some preferred embodiments of the invention, wherein:

FIG. 1 shows a front perspective view of the dispenser without a roll of expandable slit sheet material placed on the dispenser,

FIG. 2A shows a front left perspective view of the left side of the dispenser shown in FIG. 1 containing the tensioner that applies tension that facilitates expansion of the expandable slit sheet material,

FIG. 2B shows an interior view of an upper portion of the left side of the dispenser shown in FIG. 1;

FIG. 3 shows a front view of the dispenser shown in FIG. 1 with a roll of expandable slit sheet material being placed on the dispenser, and

FIG. 4 shows a front view of the dispenser shown in FIG. 1 with the roll of expandable slit sheet material fully placed on the dispenser;

FIG. 5 shows a front view of an illustrative roll of expandable slit sheet material according to some illustrative embodiments;

FIG. 6 shows a front view of an illustrative tubular core around which a roll of expandable slit sheet material can be wound in some illustrative embodiments;

FIG. 7A shows an end view of the illustrative tubular core shown in FIG. 6;

FIG. 7B shows the end view of the illustrative tubular core illustrated in FIG. 7A with a pressure member positioned inside the end of the tubular core;

FIG. 8 shows a first alternative variation of the embodiment of the dispenser shown in FIGS. 1-4 employing a lever arm that can be rotated to quickly lift the pressure member;

FIG. 9 shows a second alternative variation of the embodiment of the dispenser shown in FIGS. 1-4 employing a second spring positioned between the bottom of the pressure member and the top of the plate;

FIGS. 10-12 show an illustrative dispenser for manually dispensing expandable slit sheet material according to some other embodiments of the invention, wherein:

FIG. 10 shows a front perspective view of the dispenser without a roll of expandable slit sheet material placed on the dispenser, and

FIG. 11 shows an interior view of the left side of the dispenser shown in FIG. 10 having the tensioner that applies tension that facilitates expansion of the expandable slit sheet material;

FIG. 12 shows an exterior view of the left side of the dispenser 100′ shown in FIG. 10 having the tensioner 120′ that applies tension that facilitates expansion of the expandable slit sheet material;

FIGS. 13 and 14 show illustrative expandable slit sheet material that can be employed in some embodiments of the invention;

FIGS. 15A-15C show illustrative use of expandable slit sheet material dispensed with a dispenser according to the present invention in some illustrative implementations;

FIG. 16 shows a front perspective view of the left side of a dispenser similar to that shown in FIGS. 1 to 12 having a modified tensioner according to some alternative embodiments; and

FIGS. 17A and 17B show alternative dispenser frame structures in which a roll of expandable slit sheet paper is laterally slid over the end of a support shaft, wherein FIG. 17A is a front perspective view and FIG. 17B is a cross-sectional view taken along the line 17B-17B shown in FIG. 17A.

### DETAILED DESCRIPTION OF THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

### Illustrative Expandable Slit Sheet Material Employed in Some Embodiments

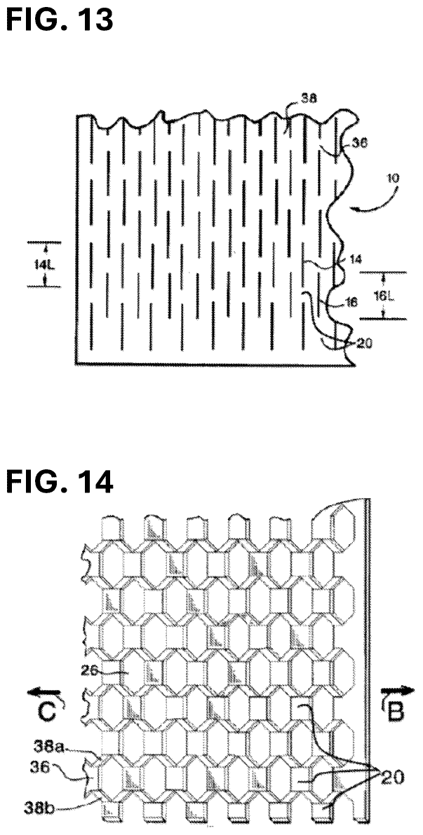

FIGS. 13-14 show an illustrative expandable slit sheet material according to some embodiments. In that regard, FIG. 13 is a plan view of an illustrative expandable slit sheet paper in an unexpanded state, and FIG. 14 is a plan view of the illustrative expandable slit sheet paper in an expanded state, which illustrative paper can be employed for expansion in illustrative embodiments of the present invention.

FIGS. 13 and 14 depict an illustrative expandable slit sheet paper that can be expanded with systems and methods of the present invention in some illustrative embodiments of the invention. Towards that end, FIG. 13 is an illustration of an exemplary slit pattern in an illustrative expanded slit sheet. The expandable slit sheet paper shown in FIG. 14 operates as an expandable cell-forming paper that can be expanded to an expanded state as shown in FIG. 14. FIG. 13 shows an illustrative section of an expandable slit sheet 10 in an unexpanded (unopened) state, with staggered rows of slits 14 and 16 that extend entirely through the width of the sheet 10, and land portions 20 extending between adjacent slits within rows 14 and 16. As shown in FIG. 13, in some preferred embodiments, the slit lengths 14L and 16L are uniform across the face of the sheet 10; similarly, the distance and area of each row spacing 38 (i.e., between adjacent rows) and each slit spacing 36 (i.e., between adjacent slits) are also uniform. Although an expandable slit sheet can be formed with a variety of slit patterns, the illustrative example shown in FIGS. 13 and 14 depict an illustrative example to scale with illustrative lengths of slits, spacing between slits, proportional relationships of sizes of created hexagonal cells, land portions and leg portions, etc., according to some illustrative examples with such as drawings being to scale in some illustrative and non-limiting embodiments. In FIG. 14, the sheet 10 shown in FIG. 13 has been subjected to an expansion force in the direction of arrows B and C and opened to an open cell formation. In that regard, in this illustrated example, the open cell formation results in hexagonal shaped cells as shown in FIG. 14. In particular, as depicted, the slits 14 and 16 are in an opened state in which the sheet 10 is oriented to have an array of three-dimensional hexagonal cells 26, with substantially rectangular land portions 20 within the slit spacings 36 situated at an inclined angle (i.e., such as to be transverse to the original plane of the sheet 10), and the leg portions 38a and 38b connecting the land portions between the row spacings having been warped to, e.g., slightly less than a 90° angle to the original plane of the sheet. The leg portions 38a and 38b are basically mirror images of one another and connect the land portions 20 such as to form the three-dimensional hexagonal cells.

In the preferred embodiments, systems and methods of the preferred embodiments of the present invention can be employed for expanding an expandable slit sheet similar to that shown in FIGS. 13 and 14.

In some preferred embodiments, the expandable slit sheet material is made from a Kraft paper. In some embodiments, the expandable slit sheet material is made from a paper having a weight, prior to expansion, between about 20 to 70 pounds per 3,000 square feet, or, in some preferred embodiments, between about 30 to 60 pounds per 3,000 square feet, or, in some preferred embodiments, between about 40 to 50 pounds per 3,000 square feet. It should be appreciated based on this disclosure (such as set forth in the last paragraphs of the specification), the weight of the paper can, in various embodiments, be any specific value within the foregoing ranges, such as, e.g., 40 pounds per 3,000 square feet, 50 pounds per 3,000 square feet, etc.

### Extensible Paper Employed in Some Preferred Embodiments

In some more preferred embodiments, the expandable slit sheet paper is made with an extensible paper. In some most preferred embodiments, extensible papers as set forth in the present inventor's U.S. Pat. No. 10,669,086 are employed, the entire disclosure of which is incorporated herein by reference.

According to some embodiments, the extensible paper is extensible in a machine direction in a range of at least 5%. According to some embodiments, the extensible paper is extensible in a cross direction in a range of at least 5%. According to some embodiments, the extensible paper is extensible in a machine direction in a range of at least 5% and in a cross direction in a range of at least 5%. According to some embodiments, the extensible paper is extensible in a machine direction in a range of at least 6% and in a cross direction in a range of at least 6%. According to some embodiments, the extensible paper is extensible in a machine direction in a range of at least 7% and in a cross direction in a range of at least 7%. According to some, most preferred, embodiments, the extensible paper is extensible in a machine direction in a range of at least 8% and in a cross direction in a range of at least 8%. According to some embodiments, the extensible paper is extensible in a machine direction in a range of between 5% to 15% and in a cross direction in a range of between 5% to 15%. According to some embodiments, the extensible paper is extensible in a machine direction in a range of between 7% to 15% and in a cross direction in a range of between 7% to 15%.

According to some illustrative embodiments, the plurality of slits each have a width of between 0.35 and 0.65 inches; according to some embodiments, the plurality of slits each have a width of between 0.45 and 0.55 inches. According to some embodiments, the plurality of slits each have a width of about 0.5 inches. According to some embodiments, the plurality of slits each have a width of less than 0.5 inches. According to some embodiments, the plurality of slits each have a width of less than 0.45 inches. According to some embodiments, the plurality of slits each have a width of less than 0.4 inches.

In some more preferred embodiments, extensible papers as set forth in the above-referenced U.S. Pat. No. 10,669,086 are employed. Towards that end, the following paragraphs (in quotations) under this section are quoted from the '086 patent set forth details of extensible papers according to some preferred embodiments that can be employed in preferred embodiments of the present invention.

“For the purposes of the present invention, the term ‘extensible’ as applied to paper sheets, means a paper sheet that is able to stretch in a longitudinal direction of the paper sheet upon applying a force in the longitudinal direction of the paper sheet. Illustrative extensible sheets are disclosed in U.S. Pat. No. 3,908,071, U.S. patent application Ser. No. 14/901,977 (U.S. Pat. No. 9,945,077), International Application No. WO 1984002936, U.S. Publication Nos. 2002/0060034, 2007/0240841 (U.S. Pat. No. 7,918,966), and U.S. Pat. Nos. 3,104,197, 3,220,116, 3,266,972, 3,269,393, 3,908,071, 6,024,832, 6,458,447, and 6,712,930, the entire disclosures of which are incorporated by reference herein, as though recited in full. It should be understood that the stretching of an extensible paper must be measured in an unslit sheet of paper. As disclosed in U.S. Pat. No. 3,266,972, the test and characterization procedures employed in measuring elongation (extensibility) properties can be in accordance with standard TAPPI test Elongation T457. In addition, as disclosed in U.S. Pat. No. 3,266,972, the expression ‘extensible papers’ means a paper having an increasable elongation in the machine direction as compared to standard, non-extensible Kraft paper.”

“In some preferred embodiments, extensible paper can be produced by varying the accumulation of paper fibers by essentially slowing the paper feeding process during the drying method to trap extra fibers that make the paper appear to have microscopically sized rows of paper that you would see if one were to pleat the paper. The difference is that extensible paper's microscopic rows are adhered to each other through the use of binders and other types of adhesives in conjunction with the drying process. Reference is made to patent U.S. Application No. 2007/0240841 (U.S. Pat. No. 7,918,966) where the purpose is to create a non-creped extensible paper that does not easily disconnect from itself. In addition, the surface of the extensible paper is still fairly flat.”

“In the preferred embodiments of the present invention, the extensible paper that is employed has low extensible properties as compared to other types of extensible papers. In this regard, an optimal extensible paper enables a smooth transition from an unexpanded to the expanded slit sheet by providing a small amount of stretching at the very start of expansion of the extensible slit sheet paper material.”

“In some exemplary constructions, during expansion of a slit sheet, the force required to initiate expansion is substantially higher than the force required to continue expansion. For example, once the paper initially starts to bend at the slits, the expansion continues more easily during continued bending at the slits. The force required to continue the expansion of the slit sheet during this continued bending is dramatically reduced beyond the above-noted initial expansion. In some preferred embodiments, the extensible slit sheet paper substantially reduces the force required to initiate expansion. On the other hand, in some preferred embodiments, during the above-noted continued expansion, the extensible paper does not substantially stretch simultaneously with the process of expanding the slit sheet paper; otherwise, the expanded sheet might not optimally be made into a cushioning wrap.”

“It should be noted that in this application, all theories related to functioning of the invention are provided to facilitate appreciation of concepts of the invention, rather than by way of limitation. Extensible paper, as designed, stretches as part of an increase in paper strength. In some embodiments, the functioning of the invention involves that the extensible slit sheet paper substantially utilizes the extensible property to ease the rotating the cells into the stretched shape and to resist tearing of the slit sheet during the expansion step. This means that at the initial point at which the cell rotates (i.e., initiating rotation between legs 38a and 38b on each side of the slit and land 20) the extensible slit sheet paper is substantially enhanced by the extensible paper's ability to stretch. In some embodiments, the functioning of the invention, thus, involves that extensible papers' properties are substantially utilized at this initial point and substantially finished as soon as the cell begins to rotate into its three-dimensional shape (i.e., after this initial point, the reliance on the extensible nature of the paper may be less substantial or even non-existent). After that initial point, the slit pattern properties, regardless of paper type, opens with greater ease to the point at which it forms a hexagon. Accordingly, in some embodiments, the extensible property substantially merely comes into play at the initial moment of expansion. In some other embodiments, while the extensible features of the paper comes into play most substantially at this initial point of rotation, the extensible features of the paper can have some affect during further expansion of the paper, whereby the initial point of expansion can be substantially facilitated due to extensibility and further expansion can also be, at least, somewhat facilitated due to extensibility.”

“In some of the preferred embodiments, preferable extensible papers that can be employed include extensible papers where the purpose of the extensible nature is to provide the type of stretching found for the use of multi-wall bags for heavy weight items like cement, or seed and the like. U.S. Patent Publication No. 2016/0355985 (U.S. application Ser. No. 14/901,997) and U.S. Pat. Nos. 3,104,197 and 3,266,972 teach the manufacture and properties of this form of extensible paper. Further teachings can be found in “Understanding sheet extensibility”, R. S. Seth, Pulp & Paper Canada T31, 106:2 (2005) III, pages 33-40 (T31-T38). The disclosures of the foregoing patents, patent publication, and printed publication are incorporated herein by reference, as though recited in full.”

“The prior expanded slit sheet art (See, e.g., U.S. Pat. Nos. 5,538,778, 5,667,871, 5,688,578, and 5,782,735) focused on paper strength to inhibit tearing during the expansion process and Kraft paper was satisfactory because the strength required coincided with the thickness required to make a satisfactory wrapping product. The increased strength of an expandable sheet does not contribute to or increase the value/performance of the expansion of the slit sheet material. It has now been found by the present inventor that an expandable slit sheet paper can be substantially improved by the use of an extensible sheet. In the preferred embodiments, this use of an extensible slit sheet paper advantageously provides a reduction in force required to open the slit sheet and therefore provides a faster and easier expanding process for the user of the expanded slit sheet. The unexpected benefit resulting from the reduction in force at the very start of the expansion of the slit sheet provides an unexpected improvement to the slit sheet packaging product and renders the employment of the extensible paper highly unique. Notably, the prior expanded slit sheet paper persisted in and was widely used in the marketplace for decades without the contemplation of the present invention or the potential advantages therefrom.”

“As set forth in this application, the present inventor has discovered that the force needed to expand an expandable slit sheet paper is far greater than the force required to expand an extensible slit sheet paper. By way of example, a 50 pound Kraft paper expandable slit sheet that is 15” wide prior to expansion requires approximately 4-6 pounds or 0.4 pounds per inch, whereas the force required to expand an extensible slit sheet of the same paper weight is 0.15-0.22 pounds per inch. This is a marked difference between the papers. Kraft paper has the strength to provide an acceptable expandable slit sheet. However, unexpectedly, the extensible slit sheet imparts an ease of expansion that greatly reduces the force required to expand the slit sheet, not based on the main purpose for extensible paper which is to increase its tensile strength but, rather, its capability to stretch. Since extensible paper is higher in cost and Kraft paper was strong enough, it was not previously known that extensible paper could be of benefit for making slit paper sheets of the types found in, e.g., U.S. Pat. Nos. 5,538,778, 5,667,871, 5,688,578, and 5,782,735, and U.S. Non-Provisional application Ser. No. 15/428,144. For example, it was not appreciated that an extensible slit sheet could have provided an equivalent strength to light weight, thin papers that previously had no applicability as a wrapping product. Light weight Kraft paper tears more easily than heavier weights of Kraft paper. It has now been found that the extensible paper enables the use of the lighter weight expanded slit-sheet papers that also advantageously provide gentler cushioning required by fragile items when a slit sheet is expanded, in contrast to the more rigid cushioning provided by heavier weight expanded slit-sheet papers.” “Reference is particularly made to the graph of Table 1 on page 5 of U.S. Patent Publication No. 2016/0355985 (now U.S. Pat. No. 9,945,077) as if recited in full, that describes paper strength based on certain manufacturing techniques. Within the graph is a column describing elongation at the point of paper break (or tearing of fibers) separated into two sub columns of the machine direction (MD) and cross direction (CD), also referred to as transverse direction. The elongation percentage of Table 1 ranges from 5.3% to 7.1% in the cross direction (CD) and 3.3% to 10.6% in the machine direction (MD).”

“Reference is also made to U.S. Pat. No. 3,266,972 within Table Ill of column 5 which references elongation in the percentage range from 3.7% to 4.6% in the CD or cross direction and 9.7% to 11.1% in the machine direction.”

“In combination with the extensible paper, a smaller, lighter weight, and recyclable version of an expander can be employed (such as, e.g., made entirely or substantially entirely with recyclable cardboard in some illustrative embodiments). This expands the market to customers that use a very small amount of wrap as compared to the industrial market. It also provides for a less expensive expansion device to be employed for expanding the slit paper. Additionally, it enhances the ease of use by the packer by providing for less ripping during the wrapping process that occurs when the tension is not properly set. This occurs as the roll, during its continued use, becomes smaller and lighter in weight. As the roll of expanded slit sheet becomes lighter the tension required increases. Thus, there need for a varying tensioning method. With the use of the extensible paper, the tension required is significantly decreased and the strength of the paper is increased. Both benefit the person wrapping by making the tensioning required much less precise to the point at which, a single tension setting can be used with little or no adjustment. If the tension is set higher than necessary, the increase in strength from the extensible paper keeps the product from tearing and therefore makes it easier for the packer to use. Therefore, the packer can make fewer adjustments as the slit sheet roll becomes smaller and smaller.”

“The reduction in the force required to expand the slit paper enables a new product to be created using lighter weight papers. In the past, expanded slit sheet paper is primarily used as a wrapping product whereas its use as a void fill would be in limited circumstances due to void fill being typically the cheapest, that is, the lowest cost of all packaging products. The increased strength of the extensible sheet enables the use of a thinner and lighter weight slit sheet paper as a void fill product. If the expanded slit sheet is not being used as a wrap, then the thicker 0.005″, 50 pounds per 3,000 square feet paper and above is not required and a lighter weight 0.003-0.0045″ thick, 30-40 pounds per 3,000 square feet paper can be used as void fill. It can also be used to provide cushioning that other paper void fill products have not been able to provide. It has now been found that even though the extensible paper has a 10% higher price, the use of a thinner paper provides much more square footage per ton and more than compensates for the increased cost of the extensible paper as compared to Kraft paper.”

### ILLUSTRATIVE EMBODIMENTS

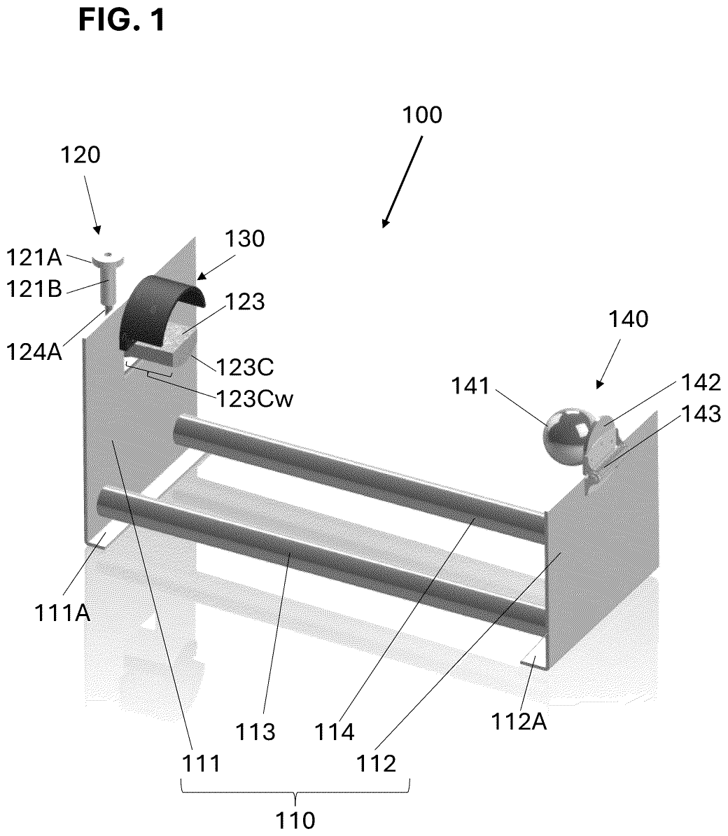

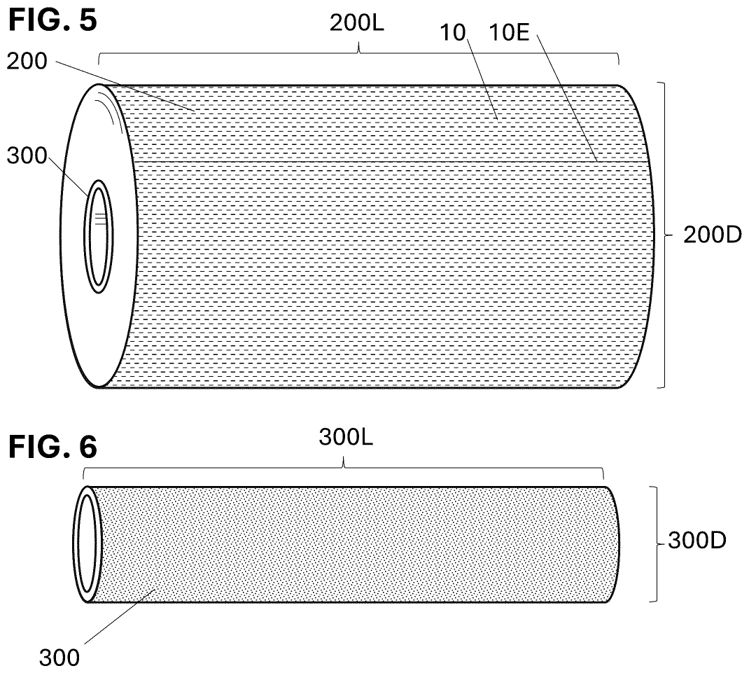

FIGS. 1-4 show an illustrative dispenser 100 for manually dispensing expandable slit sheet material according to some preferred embodiments of the invention, and FIGS. 5-7B show details related to an illustrative roll 200 of expandable slit sheet material (e.g., expandable slit sheet paper) and an illustrative core 300 around which the roll 200 is wound employed with the dispenser 100 according to some preferred embodiments of the invention.

FIG. 1 shows a front perspective view of the dispenser 100 without a roll of expandable slit sheet material placed on the dispenser.

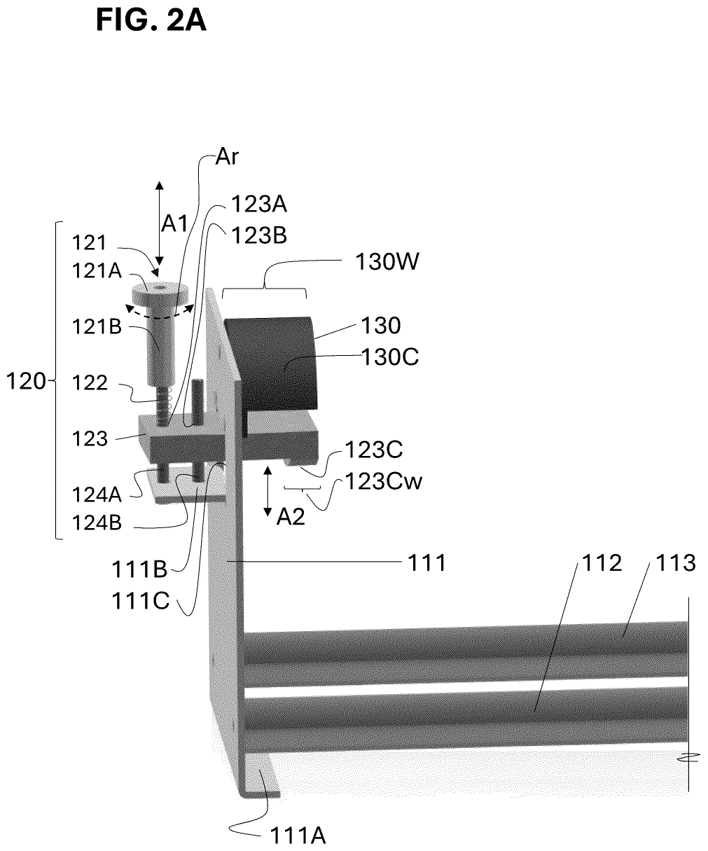

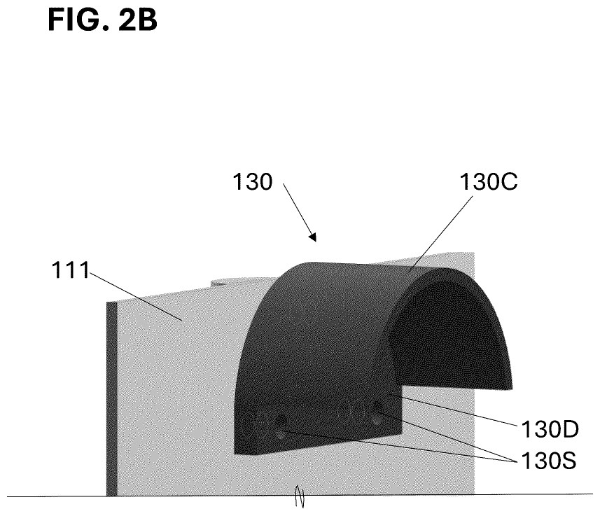

FIG. 2A shows a front left perspective view of the left side of the dispenser 100.

FIG. 2B which shows an interior view of an upper portion of the left side of the dispenser shown in FIG. 1.

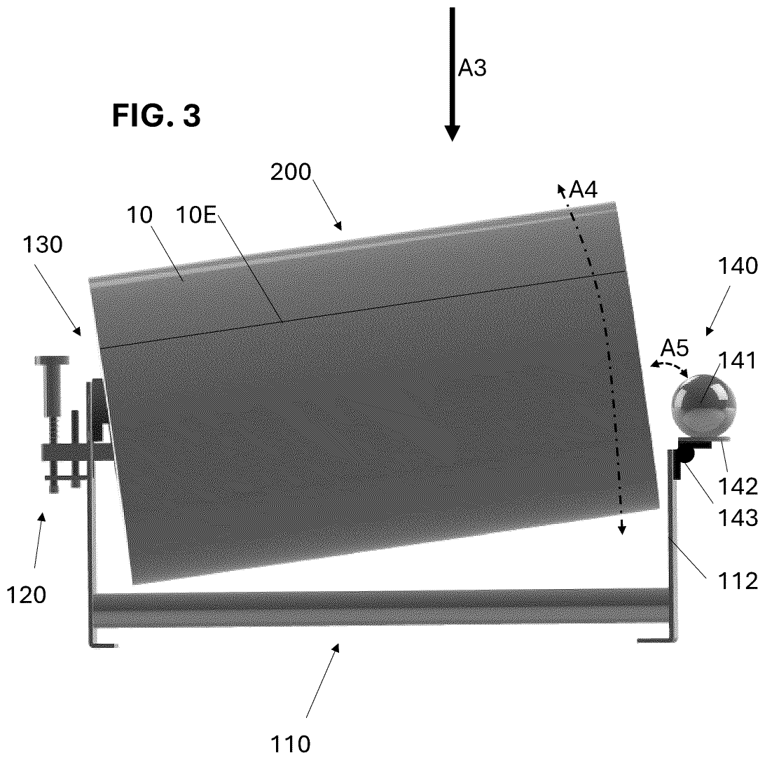

FIG. 3 shows a front view of the dispenser 100 shown in FIG. 1 with a roll 200 of expandable slit sheet material being placed on the dispenser 100.

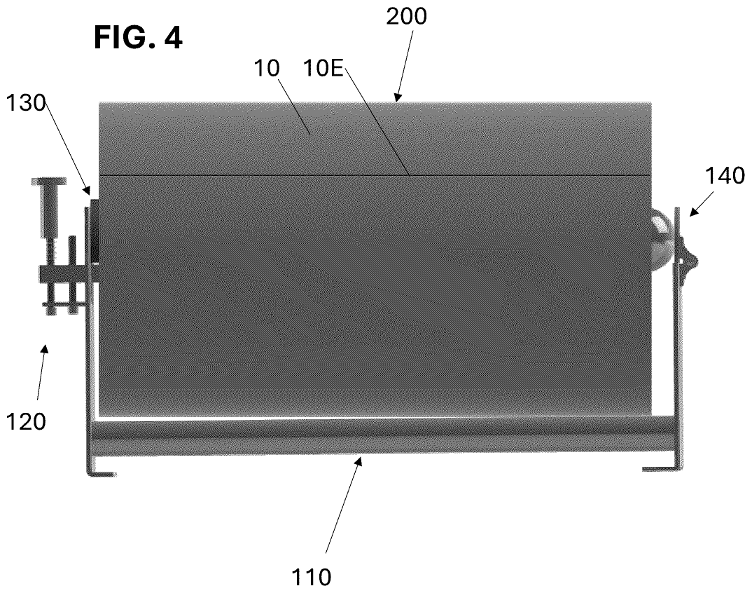

FIG. 4 shows a front view of the dispenser 100 shown in FIG. 1 with the roll 200 of expandable slit sheet material fully placed on the dispenser 100.

FIG. 5 shows a front view of an illustrative roll 200 of expandable slit sheet material 10 according to some illustrative embodiments.

FIG. 6 shows a front view of an illustrative tubular core 300 around which a roll 200 of expandable slit sheet material 10 can be wound in some illustrative embodiments.

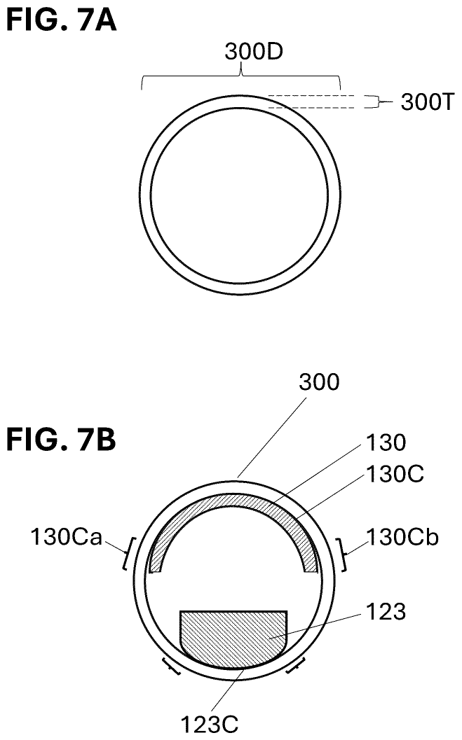

FIG. 7A shows an end view of the illustrative tubular core 300 shown in FIG. 6.

FIG. 7B shows the end view of the illustrative tubular core 300 illustrated in FIG. 7A with a pressure member 123 positioned inside the end of the tubular core 300.

With reference to FIG. 1, FIG. 1 shows a front perspective view of the dispenser 100 without a roll of expandable slit sheet material placed on the dispenser. The dispenser 100 shown in FIG. 1 is configured to support a roll 200 of expandable slit sheet material 10 such as, e.g., expandable slit sheet paper (see, e.g., FIGS. 3-5). In operation, a user can manually grasp a distal end 10E of the expandable slit sheet material 10 and manually pull the expandable slit sheet material as described in the patents and patent publications of the background art incorporated by reference above for wrapping items for packaging and shipping purposes and the like.

As shown in FIG. 1, the dispenser 100 includes a frame 110. The frame 110 is preferably made of metal, such as, e.g., aluminum, stainless steel or the like, but can be made with other materials such as wood, plastic, ceramic or other suitable materials in other embodiments. The frame includes a first support wall 111, a second support wall 112, and at least one connecting member extending between the first support wall 111 and the second support wall 112. In the illustrated embodiment, the at least one connect member includes a first connecting member 113 and a second connecting member 114.

The first support wall 111 includes a first core support 130 on an interior side of the first support wall 111 (i.e., on the side of the first support wall 111 facing the second support wall 112). The first core support 130 includes a curved support surface 130C that is configured to be received within an open end of the core 300 around which the roll 200 of expandable slit sheet material is wound (see, e.g., FIGS. 5-7B). In the preferred embodiments, the curved support surface 130C is substantially circular with a radius of curvature the same or about the same as that of the interior of the core 300 such that the cylindrical interior surface of the core 300 rests upon the curved support surface 130C when placed thereover. In the illustrative example shown in FIG. 7B, the curved support surface 130C extends approximate 180 degrees (i.e., ½) of the circular interior of the core 300. In preferred embodiments, the curved support surface 130C extends around at least 45 degrees (i.e., ⅛) of the circular interior of the core 300. In more preferred embodiments, the curved support surface 130C extends around at least 90 degrees (i.e., ¼) of the circular interior of the core 300. In more preferred embodiments, the curved support surface 130C extends around at least 120 degrees (i.e., ⅓) of the circular interior of the core 300.

In some embodiments, the curved support surface 130C can extend greater than 180 degrees around the circular interior of the core 300 or even entirely (i.e., 360 degrees) around the interior of the core 300 (e.g., with an opening via which a pressure member [e.g., see pressure member 123 discussed below] can extend similarly to that shown in U.S. Patent Publication No. 2021/0315426). However, in the preferred embodiments, the first core support 130 does not extend more than 180 degrees around the circular interior of the core 300 to facilitate placement of the roll 200 of expandable slit sheet material 10 wound around the core 300 upon the first core support 130 while the axis of the roll 200 is tilted with respect to the first core support 130 as shown, by way of example, in FIG. 3.

In some embodiments, the curvature of the curved support surface 130C can be the same around the entire periphery of the curved support surface. In some other embodiments, the edge regions 130Ca and 130Cb can of the curved support surface have a greater degree of curvature to separate from the interior surface of the core 300 as shown such as to ensure a smooth rotation of the core 300 around the first core support 130. In some embodiments, the edge regions 130Ca and 130Cb can consist of a small percentage of the circumference of the curved support surface 130C, such as, e.g., a combined percentage of less than 20% of the circumference of the curved support surface, or, preferably, less than 10% of the area of the curved support surface, or, preferably, less than 5% of the area of the curved support surface.

As shown in FIG. 2B which shows an interior view of an upper portion of the left side of the dispenser shown in FIG. 1, in some embodiments, the first core support 130 preferably includes a vertical back wall 130D having a plurality of holes 130S for mounting the first core support 130 to the first support wall 111 (e.g., employing bolts or screws or the like). In various embodiments, the first core support 130 can be mounted or attached to the first core support 130 employing any other suitable mounting techniques, such as, e.g., adhesives, welding, etc.

In some embodiments, the first core support 130 can be made with metal, such as, e.g., aluminum, stainless steel or the like, but can be made with other materials such as wood, plastic, ceramic or other suitable materials in other embodiments. In some preferred embodiments, the first core support 130 is made with an injection molded plastic.

In some embodiments, the first core support 130 extends from the interior of the first support wall 111 a length 130W (shown in FIG. 2A). In the preferred embodiments, the length 130W is short enough to enable the roll 200 of expandable slit sheet material 10 to be easily placed upon the first core support 130, while stably supporting the roll 200 during use and operation of the dispenser 100. In some embodiments, the length 130W is less than about 5 inches. In some embodiments, the length 130W is less than about 4 inches. In some embodiments, the length 130W is less than about 2½ inches. In some preferred embodiments, the length 130W is less than about 2 inches. In some preferred embodiments, the length 130W is less than about 1½ inches. In some preferred embodiments, the length 130W is less than about 1 inch. In some embodiments, the length 130W is also greater than about ½ inch. In some embodiments, the length 130W is also greater than about 1 inch. In some preferred embodiments, the length 130W is between about ½ inch and 5 inches. In some preferred embodiments, the length 130W is between about ½ inch and 2½ inches. In some preferred embodiments, the length 130W is between about 1 inch and 2 inches. In some preferred embodiments, the length 130W is about 1½ inches.

In some implementations, the roll 200 of expandable slit sheet material has a length 200L (see FIG. 5) of between about 10 to 20 inches. In some preferred implementations, the roll 200 has a length 200L of between about 12½ and 17½ inches. In some preferred embodiments, the roll 200 has a length 200L of about 15 inches. In some exemplary embodiments, the roll 200 has a length 200 of about 15¼ inches.

In some implementations, the roll 200 of expandable slit sheet material has an initial diameter 200D (see FIG. 5) of between about 6 to 12 inches. In some preferred implementations, the roll 200 has a diameter 200D of between about 8 and 10 inches. In some preferred embodiments, the roll 200 has a diameter 200D of about 9 inches.

In the preferred implementations, the core 300 has a length 300L (see FIG. 6) that is equal to or less than the length 200L of the roll 200. In the most preferred implementations, the core 300 has a length 200L that is the same or about the same as the length 200L of the roll. In the preferred embodiments, the core 300 has a diameter of between about 1½ to 4½ inches. In some preferred embodiments, the core 300 has a diameter of between about 2 to 4 inches. In some preferred embodiments, the core 300 has a diameter of between about 2½ to 3½ inches. In some exemplary embodiments, the core 300 has a diameter of about 3¼ inches.

In some preferred embodiments, the core 300 has a thickness 300T (see FIG. 7A) of between about 1/16 inch and ¼ inch. In some exemplary embodiments, the core 300 has a thickness 300T of about ⅛ inch.

In the preferred embodiments, the roll 200 of expandable slit sheet material and the core 300 are both recyclable. In the preferred embodiments, the core is made with a recyclable paper, paperboard, or cardboard. In the preferred embodiments, the core is sufficiently rigid to maintain a substantially cylindrical tubular shape during support the roll 200 and use of the dispenser 100 for manual dispensing expandable slit sheet material.

In some exemplary implementations, a) the core 300 has a length of about 15¼ inches, an outer diameter of about 3¼ inches, and a thickness of about ⅛ inch, and b) the roll has a length of about 15¼ inches and an outer diameter of about 9 inches, c) the first core support 130 has a length 130W of about 1 inch to 2½ inches (or, preferably, about 1¼ inch to 2 inches, or, preferably, about 1½ inch).

As shown in FIG. 2A, which shows a front left perspective view of the left side of the dispenser 100 shown in FIG. 1, the first support wall 111 preferably supports a tensioner 120 that applies tension that enables expansion of the expandable slit sheet material which a distal end of the expandable slit sheet material is manually pulled.

As shown in FIG. 2A, the tensioner 120 includes a pressure member 123 having a curved pressure surface 123C on an interior side of the pressure member 123 that is configured to be received within an open end of the core 300 around which the roll 200 of expandable slit sheet material is wound (see, e.g., FIGS. 5-7B) underneath the first core support 130. In the preferred embodiments, the curved pressure surface 123C is substantially circular with a radius of curvature the same or about the same as that of the interior of the core 300 such that the curved pressure surface 123C applies an even or substantially even pressure along its entire surface against the cylindrical interior surface of the core 300 when pressed there-against. In the illustrative example shown in FIG. 7B, the curved pressure surface 123C extends approximately 60 degrees (i.e., ⅙) of the circular interior of the core 300. In preferred embodiments, the curved pressure surface 123C extends around at least 10 degrees (i.e., 1/36) of the circular interior of the core 300. In more preferred embodiments, the curved pressure surface 123C extends around at least 20 degrees (i.e., 1/18) of the circular interior of the core 300. In more preferred embodiments, the curved pressure surface 123C extends around at least 30 degrees (i.e., 1/12) of the circular interior of the core 300. In other preferred embodiments, the curved pressure surface 123C extends around at least 45 degrees (i.e., ⅛) of the circular interior of the core 300. In various other embodiments, the curved pressure surface 123C extends around greater than 60 degrees around the circular interior of the core 300, such as, e.g., greater than 90 degrees around, or, in some embodiments, greater than 120 degrees around. It should be appreciated that values greater than about 180 degrees would be too large to enable the pressure member 123 to be vertically moved within the circular interior of the core 300.

In the embodiment shown in FIGS. 1-4, the pressure member 123 extends inwardly from the interior of the first support wall 111 about the same distance as the length 130W of the first core support 130.

In some embodiments, the curved pressure surface 123C extends along the entire length of the pressure member 123 on the interior side of the first support wall 111. For example, as shown in FIG. 1, in some embodiments, the curved pressure surface 123C extends along the entire length 123Cw of the pressure member 123C on the interior side of the first support wall 111. In other implementations, as shown, for example, in FIG. 2A, the curved pressure surface 123 extends along a portion of the length of the pressure member 123C on the interior side of the first support wall 111. For example, as shown in FIG. 2, the length 123Cw of the curved pressure surface 123C shown in FIG. 2 is less than about ½ of the entire length of the pressure member 123 on the interior side of the first support wall 111. In some embodiments, the length 123Cw can be between about ¼ inch to about 2 inches, or, in some embodiments, between about ½ inch to 1½ inches, or, in some embodiments, between about ¾ inch and 1¼ inches. In some preferred embodiments, the curved pressure surface 123C, thus, contacts an interior surface of the core, such as, e.g., an interior cylindrical surface of the core. In some preferred embodiments, the curved pressure surface 123C contacts an interior cylindrical surface of the core at a distance between about ½ inch to 5 inches from the end of the core. In some preferred embodiments, the curved pressure surface 123C contacts an interior cylindrical surface of the core 300 at a distance between about 1 inch to 4½ inches from the end of the core 300. In some preferred embodiments, the curved pressure surface 123C contacts an interior cylindrical surface of the core at a distance between about 1½ inches to 4 inches from the end of the core. In some preferred embodiments, the core 300 has a length of between about 10 to 25 inches, or, in some preferred embodiments, between about 15 to 20 inches. In some embodiments, the interior diameter of the core 300 is between about 2 to 4 inches. In some embodiments, the interior diameter of the core 300 is between about 2½ to 3½ inches.

In some embodiments, the pressure member 123 can be made with metal, such as, e.g., aluminum, stainless steel or the like, but can be made with other materials such as wood, plastic, ceramic or other suitable materials in other embodiments. In the preferred embodiments, the curved pressure surface 123C is smooth. In some embodiments, the curved pressure surface 123C has a roughened texture to enhance friction applied to the interior of the core 300.

In the preferred embodiments, the pressure member 123 operates as a linearly reciprocated lever arm that applies a pressure force via the curved pressure surface 123C on the interior of the tubular core.

As shown in, e.g., FIGS. 1, 2A and 2B, in the illustrated embodiment, the pressure member 123 is preferably an elongated member that extends through a rectangular opening 111C in the first support wall 111. As also shown, a laterally extending plate 111B is supported on the first support wall beneath the opening 111C for supporting the pressure member 123. As best seen in FIG. 2A, in the illustrated embodiment, the laterally extending plate 111B has two vertical shaft members 124A and 124B fixedly attached thereto that extend upwardly from the top of the plate 111B. As also shown in FIG. 2A, the pressure member includes corresponding through holes 123A and 123B that each receive respective ones of said vertical shaft members 124A and 124B.

In some embodiments, the opening 111C is formed by cutting three sides of a rectangle in the first support wall 111 and bending the rectangular region around the remaining uncut bottom side of the rectangle, such as to form the laterally extending rectangular plate 111B beneath the opening 111C. In other embodiments, the plate 111B can be formed from a separate member that is fixedly attached to the exterior side of the first support wall 111.

In the illustrated embodiment, the upper end of the first vertical shaft member 124A has threads around the periphery of the shaft member 124A and receives a rotary member 121 having an internally-threaded central receiving channel that threadingly engages with the threads of the shaft member 124A. In the illustrated embodiment, the rotary member 121 includes a head portion 121A that is configured to be manually rotated by a user and a cylinder portion 121B having the internally-threaded central receiving channel. In the preferred embodiments, the head portion 121A is manually grasped by a user and operates as a grip or handle that is manually manipulated by a user. As used herein, the terminology “handle” or “handle member” means an element that is manually grasped by a user. In this manner, upon rotation of the rotary member 121 in the direction of the arrows Ar shown in FIG. 2A, the rotary member 121 is caused to move in the direction of the arrows A1 shown in FIG. 2A. As also shown, a spring 122 is positioned to surround the shaft member 124, and such that a first, upper, end of the spring 122 abuts a lower distal end of the cylinder portion 121B of the shaft member 124A and such that a second, lower, end of the spring 122 abuts an upper surface of the pressure member 123.

In the illustrated embodiment, the second vertical shaft member 124B, which is fixedly attached to the plate 111B, extends substantially parallel to the first vertical shaft member 124A, such that the pressure member 123 can be raised and lowered in the direction of the arrows A2 shown in FIG. 2A by sliding along the first vertical shaft member 124A and the second vertical shaft member 124B, with the second vertical shaft member 124B being received within the through hole 123B and the first vertical shaft member 124A being received within the through hole 123A. In the preferred implementations, the second vertical shaft member 124B is preferably not threaded such that the pressure member 123 slides smoothly along the shaft member 124B. In some preferred implementations, the portion of the first vertical shaft member 124A along which the pressure member 123 slides during use is unthreaded to facilitate sliding of the pressure member 123 smoothly along the shaft member 124A.

In this manner, when a user manually rotates the rotary member 121, due to the threaded engagement between the rotary member 121 and the shaft member 124A, the distance between the lower distal end of the cylinder portion 121B and the upper surface of the pressure member 123 can be decreased or increased based on the direction of rotation of the rotary member. In this manner, a user can manually rotate the rotary member in a first direction (e.g., clockwise in some embodiments) to cause the spring 122 to increasingly compress to adjustably increase the applied pressure to a desired pressure when the curved pressure surface 123C of the pressure member is against an inside surface of the core 300, and a user can manually rotate the rotary member in a second direction (e.g., counterclockwise in some embodiments) in a manner to cause the spring 122 to adjustably decrease the applied pressure. In some embodiments, continued rotation of the rotary member in the second direction (e.g., counterclockwise) can enable the pressure member 123 to be displaced upwardly closer to the first core support 130 to facilitate placement of the core 300 concurrently over the first core support 130 and the pressure member 123 during loading of the roll 200 of expandable slit sheet material 10.

As shown in FIGS. 1, 3 and 4, in the illustrated embodiment, the second support wall 112 of the frame 110 supports a second core support 140. In the illustrated embodiment, the second core support 140 includes a ball member 141 that is supported upon a plate 142 that is pivotally attached to an upper end of the second support wall via a spring-biased hinge 143. The spring-biased hinge 143 includes a spring that biases the hinge to the vertical position shown in FIG. 1 in which the plate 142 is substantially parallel to the second support wall 112. In operation, a user can manually grasp the ball member 141 and rotate the ball member from the position shown in FIG. 1 outwardly to, for example, a position like that shown in FIG. 3 in which the plate 142 is angled with respect to the second support wall 112. In this manner, as shown in FIG. 3, during loading of a roll 200 of expandable slit sheet material upon the frame 112, a user can manually rotate the ball member from the position shown in FIG. 1 along the direction of the arrow A5 shown in FIG. 3, such that the second core support is displaced outwardly from the end of the roll 200 and the roll can be lowered into a mounting position on the frame 110. For example, the opposite end of the roll 200 can be initially manually placed by a user upon the first core support 130 by placing the opposite end of the core 300 upon the first core support 130, and then the end of the roll 200 adjacent the second core support 140 can be lowered along the direction of the arrow A4 shown in FIG. 3. Then, once the roll 200 is lowered to a proper (e.g., generally horizontal) mounting position on the frame (such as, e.g., similar to the position shown in FIG. 4), the user can release the ball member 140 and allow the ball member 140 to be biased into the open end of the core 300 at the side of the core opposite to the first core support 130.

In the illustrated embodiment, the ball member 141 includes a ball-shaped portion (e.g., which can be spherical or substantially spherical) having an outer radius of curvature that is the same or about the same as that of the interior of the core 300 (similarly to the radius of curvature of the curved pressure surface 123C) so that the ball member 141 fits within the core 300 in a stable manner without substantial freedom of movement of the core 300 around the ball member 141 other than rotational movement around the ball member to inhibit rocking or shaking of the core 300 upon the ball member 141 during use.

In the preferred implementation of the embodiment shown in FIGS. 1-4, when a new roll 200 of expandable slit sheet material 10 is fully loaded onto the dispenser 100, the first connecting member 113 and the second connecting member 114 are positioned close to the bottom end of the roll 200. For example, in a fully loaded state shown in FIG. 4, the bottom end of the roll 200 is preferably within about 1/16 inch to ¾ inch from the first connecting member 113 and the second connecting member 114, or, more preferably, about ⅛ inch to ½ inch therefrom, or, more preferably, about ¼ inch therefrom. In this manner, a user can initially rest the bottom of the roll 200 upon the upper surfaces of the first connecting member 113 and the second connecting member 114 to facilitate alignment of the core 300 with the first core support 130 and/or the second core support 140 prior to fully mounting of the roll 200 upon the first core support 130 and/or the second core support 140.

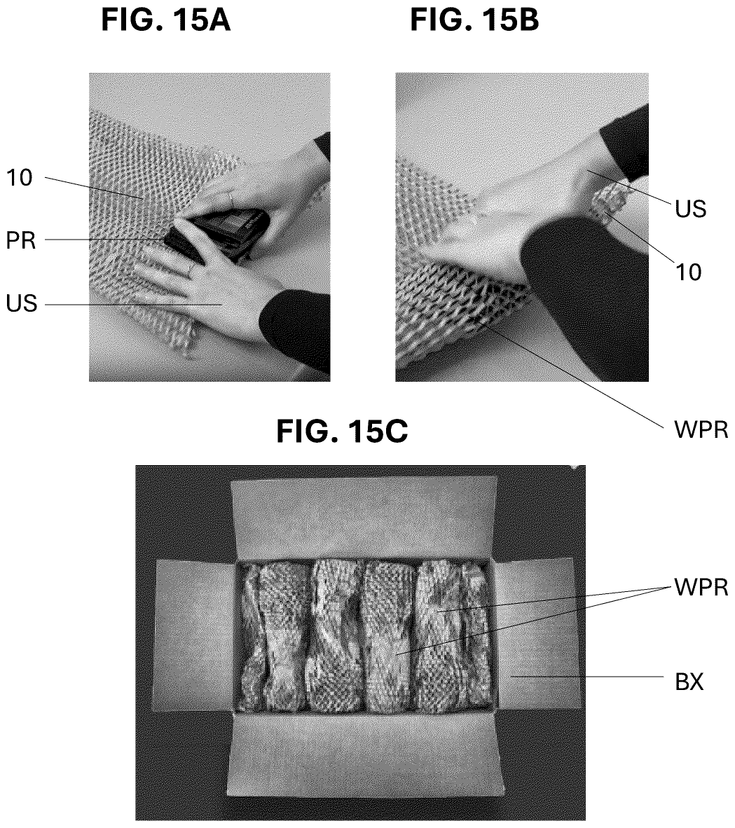

Once a roll 200 of expandable slit sheet material is in the fully loaded state on the dispenser 100, the user can use the dispenser to expand and dispense expandable slit sheet material employing methods and techniques as described in the patents and patent publications incorporated herein by reference in the background of the present application. For example, the user can adjust the tension applied to the interior of the core 300 via the pressure member 123 by manually rotating the rotary member 121 to create a desired resistance such that the expandable slit sheet material 10 expands. Then, when a desired tension is selected, a user can grasp the distal end 10E of the expandable slit sheet material within the roll 200 (see, e.g., FIG. 4). Then, as shown in FIG. 15A, the user US can pull the expandable slit sheet material 10 so that the cells of the material expand into open cells, and the user can place an item or product PR on the expanded paper for wrapping. Then, as shown in FIG. 15B, the user can wrap the item or product to create a plurality of layers of expanded slit sheet material protectively around the item or product to create a wrapped item or product WPR. Then, as shown in FIG. 15C, the user can place one or more wrapped item or product WPR within a package or box BX for storage, packaging and/or shipping.

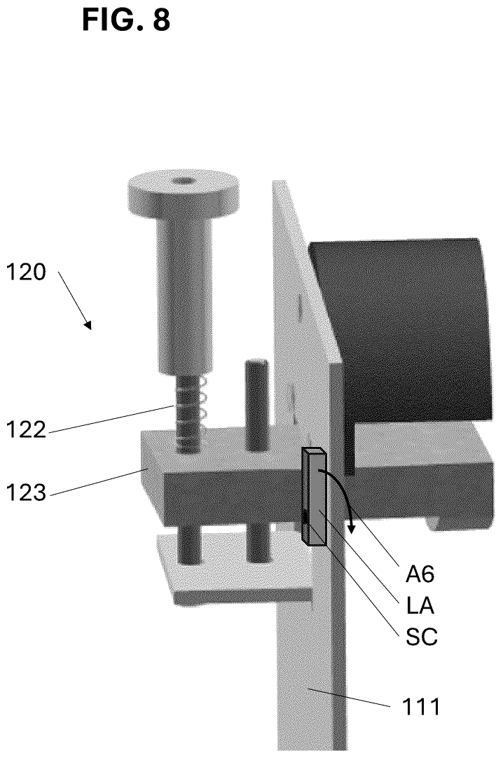

FIG. 8 shows a first alternative variation of the embodiment of the dispenser 100 shown in FIGS. 1-4 employing a lever arm LA that can be rotated to quickly lift the pressure member 123 against the pressure of the spring 122 in order to facilitate loading of a roll 200 of expandable slit sheet material by placing the core 300 concurrently over the first core support 130 and the pressure member 123 during loading of the roll 200. As shown in FIG. 8, to facilitate placement of the core 300, a user can manually grasp the top end of the lever arm LA and pull the lever arm around the pivot screw SC in the direction of the arrow A6, such that a lower end of the lever arm LA contacts a bottom end of the pressure member 123 and raises the pressure member. In some embodiments, the position of the lever arm LA with respect to the first support wall 111 can be retained using a ratchet mechanism.

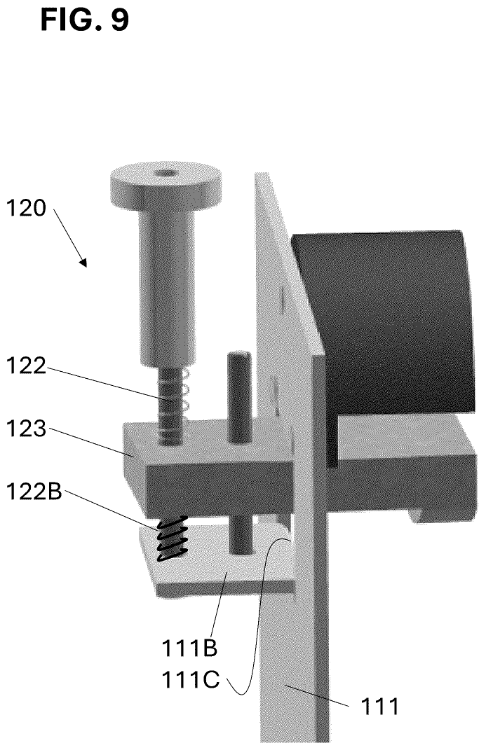

FIG. 9 shows a second alternative variation of the embodiment of the dispenser 100 shown in FIGS. 1-4 employing a second spring 122B positioned between the bottom of the pressure member 123 and the top of the plate 111B. In some embodiments, upon rotation of the rotary member 121 sufficiently to release the pressure applied by the spring 122, the second spring 122B will cause the pressure member to lift upwardly such that the pressure member 123 is moved upwardly to facilitate loading of a roll 200 of expandable slit sheet material by placing the core 300 concurrently over the first core support 130 and the pressure member 123 during loading of the roll 200.

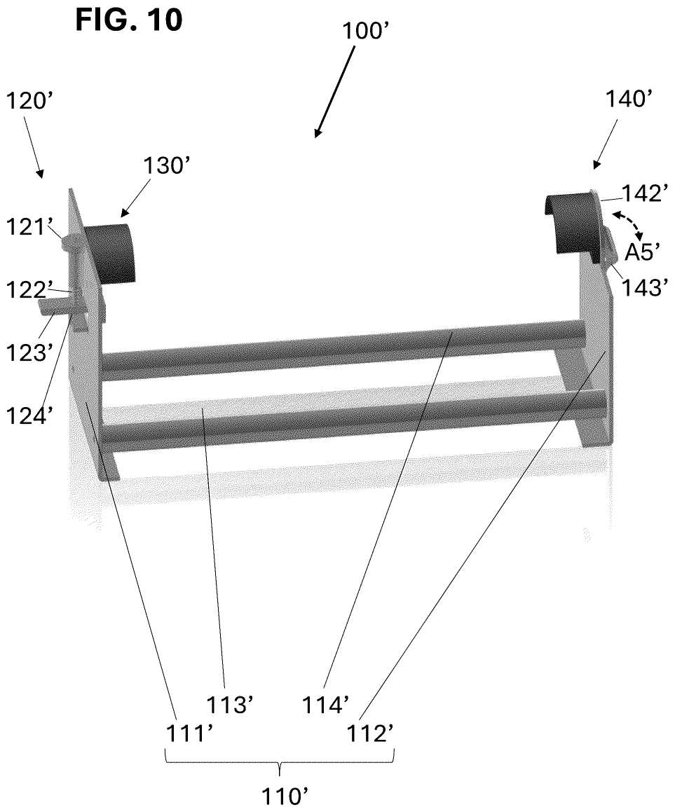

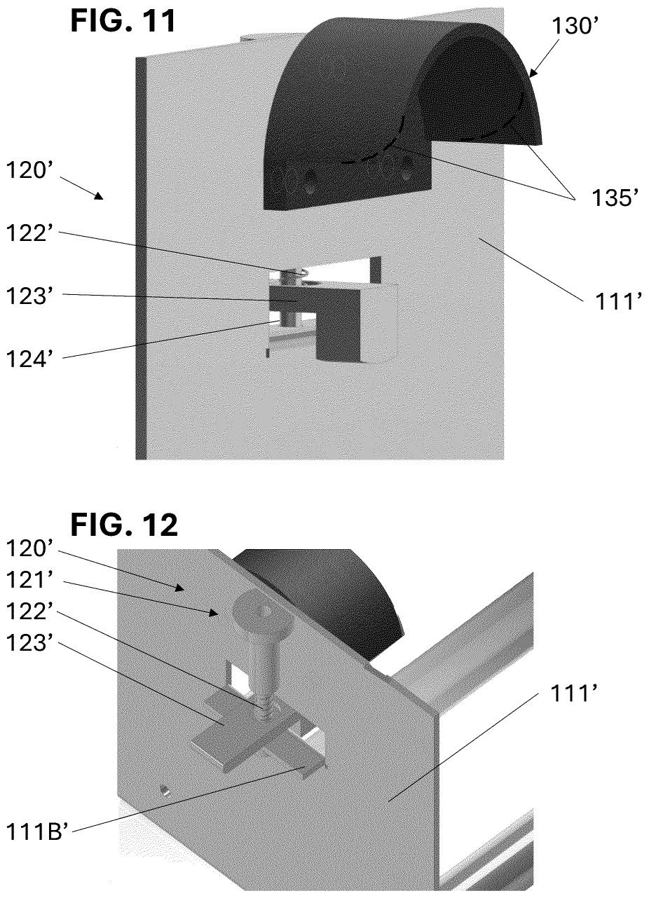

FIGS. 10-12 show an illustrative dispenser 100′ for manually dispensing expandable slit sheet material according to some other embodiments of the invention. As shown in FIG. 10, the dispenser 100′ is similar to the dispenser 100 described herein-above. FIG. 10 shows a front perspective view of the dispenser 100′ without a roll of expandable slit sheet material placed on the dispenser. FIG. 11 shows an interior view of the left side of the dispenser 100′ shown in FIG. 10 having the tensioner 120′ that applies tension that facilitates expansion of the expandable slit sheet material. FIG. 12 shows an exterior view of the left side of the dispenser 100′ shown in FIG. 11 having the tensioner 120′ that applies tension that facilitates expansion of the expandable slit sheet material.

Components and operation of the dispenser 100′ are similar to that of the dispenser 100 discussed above. However, in the preferred implementations of the dispenser 100′, the following differences are provided from that of the dispenser 100 described above. In the figures, similar parts of the dispenser 100′ are labeled with similar reference numbers to that used in relation to the dispenser 100, except that a half-quote is added adjacent reference numbers related to the dispenser 100′.

One difference of the dispenser 100′ is that the tensioner 120′ omits the use of a second vertical shaft member 124B, but only employs a single vertical shaft member 124′, which is similar to the vertical shaft member 124 described above. Otherwise, the components and operation of the tensioner 120′ is the same as that of the tensioner 120. The tensioner 120′, thus, contains less parts and reduces manufacturing costs.

Another difference of the dispenser 100′ is that the second core support 140′ is configured similarly to the first core support 130′. Towards that end, the first core support 130′ (and, thus, the second core support 140′) are configured similarly to the first core support 130 described above in relation to the dispenser 100.

Another difference of the dispenser 100′ is that the pressure member 123′ extends a distance inwardly from the interior side of the first support wall 111′ a distance less than the distance that the pressure member 123 extends from the interior side of the first support wall 111.

With respect to FIGS. 10 and 12, although the upper end of the rotary member 121′ appears in the figure to overlap the first support wall 111′ in the drawings, it should be appreciated that the rotary member 121′ would not overlap the first support wall 111′, but would be separated from the first support wall 111′ such as to be freely manually rotatable in a like manner to the rotary member 121 described above.

As shown in dashed lines in FIG. 11, in some implementations, the bottom corners of the distal end of the first core support member 130′ can be curved or rounded such as, e.g., to follow the contour of the dashed lines 135′. Among other things, providing such a curved contour can facilitate placement of the end of the core 300 over the core support member 130′. Similarly, in some variations of the embodiment shown in FIGS. 1-4, the bottom corners of the distal end of the first core support member 130 can be similarly curved or rounded.

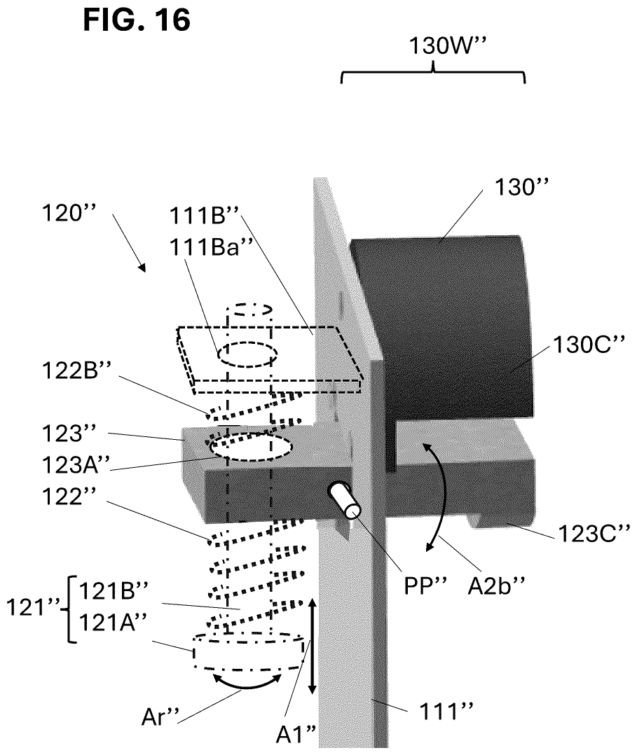

FIG. 16 shows an alternative embodiment, similar to the embodiments shown in FIGS. 1-12, wherein the tensioner 120″ is adapted to include a pressure member 123″ that is pivotally supported on a support wall 111″.

In the embodiment shown in FIG. 16, the pressure member 123″ extends from a position at an exterior side of the support wall 111″ (i.e., at the left side of the support wall 111″ shown in FIG. 16) to an interior side of the support wall 111″ (i.e., at the right side of the support wall 111″ shown in FIG. 16) such as to be received within an end of the core 300 in a manner similar to that shown and described in relation to the embodiments of FIGS. 1 to 12. However, rather than being linearly reciprocally supported on the support wall 111″, the pressure member 123″ is arcuately reciprocated by being pivotally supported on the support wall 111″.

In the preferred embodiments, the pressure member 123″ operates as an arcuately reciprocated lever arm that applies a pressure force via the curved pressure surface 123C″ on the interior of the tubular core.

In the embodiment shown in FIG. 16, a threaded shaft member 121″ having threads therearound (such as, e.g., a threaded bolt) is positioned to pass through a receiving hole 123A″ that extends entirely through the height of the pressure member 123″ at the exterior side of the support wall 111″ and that has a diameter substantially greater than a diameter of the threaded shaft 121″ passing through the receiving hole 123A″ such that the pressure member 123″ can freely rotate relative to the threaded shaft 121″ around the pivot pin PP″. As shown, the distal end of the shaft member 121″ is also received within a threaded opening 111Ba″ of a support flange 111B″ that is fixedly attached to the support wall 111″. The threads of the opening 111Ba″ threadingly engage the threads of the threaded shaft 121″ such that rotation of the threaded shaft 121″ clockwise or counterclockwise in the direction of the arrows Ar″ causes the threaded shaft 121″ to move, respectively, upwardly or downwardly in the direction of the arrows A1″. As further shown, the threaded shaft 121″ also includes a widened head portion 121A″ that is configured to be manually rotated by a user. As further shown, a spring 122″ (such as, e.g., a coil spring) is positioned to surround a threaded cylinder portion 121B″ of the threaded shaft member 121″ such that a first, upper, end of the spring 122″ abuts a lower side surface of the pressure member 123″ and such that a second, lower, end of the spring 122″ abuts an upper surface of the head portion 121A″.

As also shown in FIG. 16, the pressure member 123″ also includes a lateral through hole that receives a pivot shaft PP″. The pivot shaft PP″ extends outwardly from the lateral sides of the pressure member 123″ and is fixedly connected to the support wall 111″. In this manner, the pressure member 123″ pivots around the pivot shaft PP″ such that the interior end of the pressure member 123″ rotates, upwardly or downwardly, around the arc A2b″ during operation.

In the use of embodiment shown in FIG. 16, a user can initially manually adjust the vertical position of the head portion 121A″ such that the head portion 121A″ is in a lower position and the curved pressure surface 123C″ of the pressure member 123″ is at an elevated position, whereby the user can easily place an end of a core 300 supporting a roll of expandable slit sheet paper upon the curved support surface 130C″ of the core support 130″ with the curved pressure surface 123C″ being located within the interior of the core 300. Then, the user can next manually adjust the vertical position of the head portion 121A″ such that the head portion 121A″ is elevated and applies a pressure against a lower end of the spring 122″, which, in turn, applies a pressure against a lower end of the exterior side of the pressure member 123″ and causes the pressure member 123″ to pivot around the pivot pin PP″ such that the curved pressure surface 123C″ moves downwardly and applies a frictional pressure against a cylindrical interior surface of the core 300. In this manner, the user can adjust the desired pressure applied by the curved pressure surface 123C″ to the cylindrical interior surface of the core 300 by adjusting the rotational position of the head portion 121A″ and, hence, the vertical position of the head portion 121A″ and, hence, the amount of pressure applied through the spring 122″ to the pressure member 123″.

In some embodiments, the weight of the pressure member 123″ on the exterior side of the support wall 111″ is sufficiently greater than the weight of the pressure member 123″ on the interior side of the support wall such that the pressure member naturally assumes an angular position with the curved pressure surface 123C″ elevated when the head portion 121A″ is at a lowered position in which the spring 122″ does not apply an upward pressure force against the bottom of the pressure member 123″, such as for example when the user initially places a roll of expandable slit sheet paper upon the dispenser. However, in some alternative embodiments, in order to move the exterior side of the pressure member 123″ to a lowered position when the head portion 121A″ is at a lowered position, a second spring 122B″ can be employed which surrounds the threaded shaft 121″ and which has a lower end that abuts an upper surface of the exterior side of the pressure member 123″ and an upper end that abuts a lower surface of the support flange 111B″.

Similarly to embodiments described above in relation to the embodiments of FIGS. 1 to 12, in some implementations, the length 130W″ can be made less than about 5 inches. In some embodiments, the length 130W′″ is less than about 4 inches. In some embodiments, the length 130W′ is less than about 2½ inches. In some preferred embodiments, the length 130W″ is less than about 2 inches. In some preferred embodiments, the length 130W″ is less than about 1½ inches. In some preferred embodiments, the length 130W″ is less than about 1 inch. In some embodiments, the length 130W″ is also greater than about ½ inch. In some embodiments, the length 130W″ is also greater than about 1 inch. In some preferred embodiments, the length 130W″ is between about ½ inch and 5 inches. In some preferred embodiments, the length 130W″ is between about ½ inch and 2½ inches. In some preferred embodiments, the length 130W″ is between about 1 inch and 2 inches. In some preferred embodiments, the length 130W″ is about 1½ inches.

Similarly to the embodiments described above in relation to FIGS. 1-4, the pressure member 123″ preferably extends inwardly from the interior of the first support wall 111″ about the same distance as the length 130W″ of the first core support 130″.

Also similarly to embodiments described herein-above, in some embodiments the curved pressure surface 123C″ extends along the entire length of the pressure member 123″ on the interior side of the first support wall 111″. For example, in some embodiments, the curved pressure surface 123C″ extends along the entire length of the pressure member 123″ on the interior side of the first support wall 111″. In other implementations, as shown, for example, in FIG. 16, the curved pressure surface 123C″ extends along a portion of the length of the pressure member 123″ on the interior side of the first support wall 111″. For example, in some implementations, the length of the curved pressure surface 123C″ shown in FIG. 16 is less than about ½ of the entire length of the pressure member 123″ on the interior side of the first support wall 111″. In some embodiments, the length of the curved pressure surface can be between about ¼ inch to about 2 inches, or, in some embodiments, between about ½ inch to 1½ inches, or, in some embodiments, between about ¾ inch and 1¼ inches. In some preferred embodiments, the curved pressure surface 123C″, thus, contacts an interior surface of the core, such as, e.g., an interior cylindrical surface of the core. In some preferred embodiments, the curved pressure surface 123C″ contacts an interior cylindrical surface of the core at a distance between about ½ inch to 5 inches from the end of the core. In some preferred embodiments, the curved pressure surface 123C″ contacts an interior cylindrical surface of the core 300 at a distance between about 1 inch to 4½ inches from the end of the core 300. In some preferred embodiments, the curved pressure surface 123C″ contacts an interior cylindrical surface of the core at a distance between about 1½ inches to 4 inches from the end of the core. In some preferred embodiments, the core 300 has a length of between about 10 to 25 inches, or, in some preferred embodiments, between about 15 to 20 inches. In some embodiments, the interior diameter of the core 300 is between about 2 to 4 inches. In some embodiments, the interior diameter of the core 300 is between about 2½ to 3½ inches.

In the embodiment shown in FIG. 16, the frame of the dispenser can be formed like that shown in any of the above embodiments shown in, e.g., FIGS. 1, 2A, 3, 4 and 10, whereby a roll of expandable slit sheet paper can be mounted on the dispenser in a manner like that described herein-above. For example, in some implementations of the embodiment shown in FIG. 16, a roll 200 can be lowered onto the dispenser similarly to that shown and described herein-above (e.g., lowering the roll in the direction of the arrow A3 shown in FIG. 3). Additionally, the frame of the dispenser shown in FIG. 16 can include any of the above-described second core supports, such as, e.g., second core supports 140 or 140′. However, in some alternative implementations, the frame of the dispenser in the embodiment shown in FIG. 16 be modified to laterally slide the roll 200 over the end of a support shaft in a manner like that shown in FIGS. 1-4 of the present inventor's prior Patent Publication No. 2021/315426.

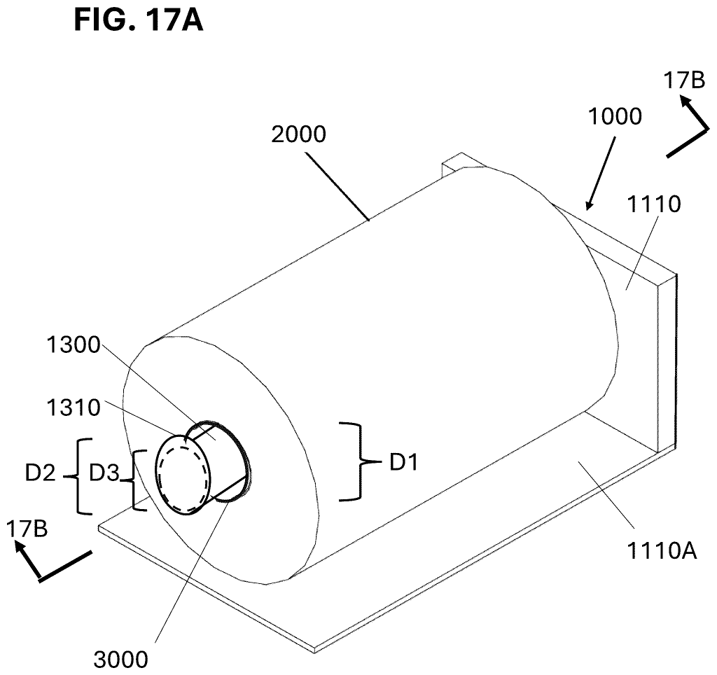

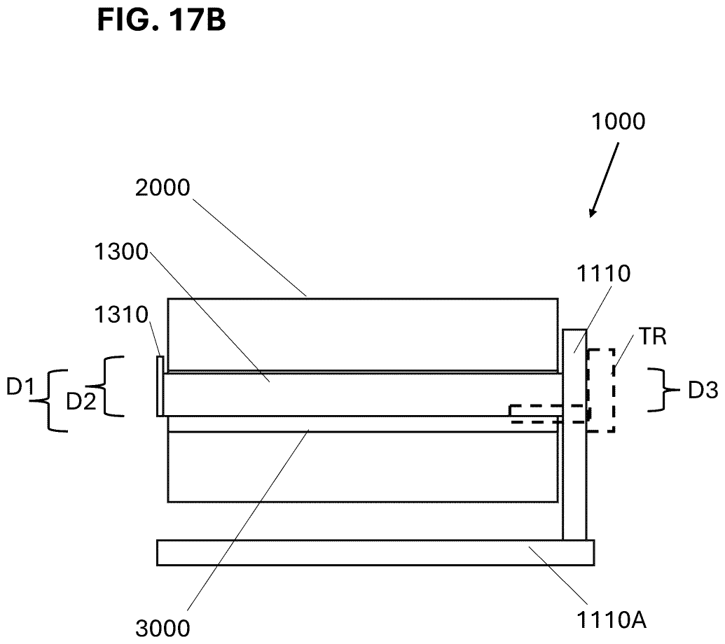

By way of example, in some alternative configurations, any of the foregoing embodiments of the present invention, including any of the embodiments shown in FIGS. 1-12 and the embodiment shown in FIG. 16 can be modified to include a frame 1000 similar to that shown in FIGS. 17A and 17B (e.g., such a frame as shown in FIGS. 17A and 17B can be implemented in conjunction with any of the corresponding tensioners 120, 120′ or 120″ shown and described above). For example, in some embodiments, the frame 1000 includes a first support wall 1110, which can be adapted to support a corresponding tensioner 120, 120′ or 120″, and a horizontal base wall 1110A upon which the first support wall 1110 is mounted. As shown in FIGS. 17A and 17B, a support shaft 1300 can be mounted to the first support wall 1110 and extend over the horizontal base wall 1110A. In the preferred implementations, the support shaft 1300 has a diameter smaller that the interior diameter of the core 3000 shown in FIGS. 17A and 17B.

Additionally, in the preferred implementations, the support shaft 1300 includes an enlarged flange portion 1310 at a distal end thereof to facilitate retention of the roll 2000 of expandable slit sheet paper supported thereon. As shown in FIGS. 17A and 17B, the internal diameter D1 of the core 3000 is set larger than both the external diameter D3 of the support shaft 1300 and the external diameter D2 of the enlarged flange portion 1310, such that both the enlarged flange portion 1310 and the support shaft 1300 are readily received through the interior of the core 3000.

As shown in FIG. 17B, any of the tensioners from all of the embodiments described herein-above (including, e.g., any of the tensioners 120, 120′ or 120″) can be employed in the embodiment shown in FIGS. 17A and 17B, as shown by the dashed lines TR. By way of example, in some embodiments the support shaft 1300 can be made with a cylindrical tube that includes an opening within the bottom adjacent the support wall 1110 to accommodate the pressure member 123, 123′ or 123″ and allow the pressure member to press against an interior of the tubular core.

Although not illustrated in FIGS. 17A and 17B, in the preferred implementations, the structure shown in FIGS. 17A and 17B will include one of the tensioners 120, 120′ or 120″ described herein above.

### Illustrative Advantages

In some preferred embodiments of the present invention, a novel combination of advantages can be achieved. For example, in some preferred embodiments, a dispenser can be provided that:
a) Applies pressure directly to a core around which expandable slit sheet is wound for tensioning. Among other things, applying friction pressure directly to a core can help to maintain the life of the tensioning mechanism. For example, because the core is a disposable component, wear of the core during usage does not lead to failure of the dispenser because each roll 200 of expandable slit sheet material has its own core. In this manner, a tension mechanism can utilize the core, as well as the core's desirable frictional qualities (e.g., the core being made with paper, paperboard, cardboard or the like), such that components of the tension mechanism are continuously replenished along with replenishment of the rolls 200.
b) Avoids an extended core having a length 300L (see FIG. 6) greater than the length 200L of the paper roll 200 (e.g., reducing costs of the extended core and handling and shipping of a roll 200 wound on an extended core).
c) Reduces the workspace area required by enabling the roll 200 to be simply lowered onto the dispenser (such as, e.g., in the direction of the arrow A3 shown in FIG. 3). For example, the first embodiment shown in FIGS. 1-4 of the present inventor's prior Patent Publication No. 2021/315426 requires a larger workspace footprint due to the need to laterally slide a roll of expandable slit sheet material on a cylindrical sleeve.

Exemplary embodiments of the present invention achieve the above and/or other notable advantages over background systems and methods.

### Broad Scope of the Invention

Within this application, the use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors such as the criticality of the slit patterns, paper width differential pre- and post-expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 15%.

All U.S. and foreign patents, patent applications, patent publications, and all other publications cited in this application are incorporated herein by reference in this application in their entireties as though recited herein in full.

What is claimed is:

1. A system for dispensing and manually expanding expandable slit sheet material, comprising:
a roll of expandable slit sheet material, said roll of expandable slit sheet material being wound around a tubular core,
a frame having a first support wall, a second support wall, and at least one connecting member extending between the first support wall and the second support wall,
said first support wall having a first core support fixedly attached thereto that extends inwardly on an interior side of the first support wall, said first core support having a curved support surface that is configured to be received within a first open end of the core,
said second support wall having a second core support fixedly attached thereto that extends inwardly on an interior side of the second support wall, said first core support having a curved support surface that is configured to be received within a first open end of the core,
said first support wall having a tensioner including a) a handle member, b) a pressure member having a curved pressure surface configured to be received within the first open end of the core proximate said first core support, and c) a spring positioned to apply pressure against said pressure member upon movement of said handle, and
wherein at least one of said first core support and said second core support are movable to enable the roll of expandable slit sheet material wound around said tubular core to be lowered upon said frame and said first core support and said second core support to be received within said core.

2. The system of claim 1, wherein said handle is a rotary member that is manually rotated.

3. The system of claim 2, wherein said spring is a coil spring that is compressed upon rotation of said rotary member.

4. The system of any of the preceding claims, wherein said expandable slit sheet material is an expandable slit sheet paper.

5. The system of claim 4, wherein said expandable slit sheet paper is an entirely recyclable paper.

6. The system of any of the preceding claims, wherein said core is made from paper, paperboard or cardboard.

7. The system of claim 6, wherein said core is entirely recyclable.

8. The system of claim 1, wherein said second core support is a ball member.

9. The system of any of claims 2-8, wherein said second core support is a ball member.

10. The system of claim 1, wherein said second core support is movably mounted on said second support wall.

11. The system of any of claims 2-9, wherein said second core support is movably mounted on said second support wall.

12. The system of claim 10, wherein said second core support is biased with a spring.

13. The system of claim 11, wherein said second core support is biased with a spring.

14. The system of claim 1, wherein said second core support is hingedly supported on said second support wall.

15. The system of any of claims 2-9, wherein said second core support is hingedly supported on said second support wall.

16. The system of claim 14, wherein said second core support is biased with a spring.

17. The system of claim 15, wherein said second core support is biased with a spring.

18. A method of manually expanding expandable slit sheet material from a manual dispenser, comprising:
a) providing a roll of expandable slit sheet material wound around a tubular core;
b) providing a manual dispenser having a frame including i) a first core support having a support surface that is configured to be received within a first open end of the tubular core and ii) a second core support having a support surface that is configured to be received within a second open end of the tubular core,
b) moving at least one of said first core support or said second core support such that a distance between an innermost end of said first core support and an innermost end of said second core support is greater than a length of said tubular core,
c) lowering said roll of expandable slit sheet material wound around the tubular core upon said frame,
d) moving at least one of said first core support or said second core support such that i) the distance between the innermost end of said first core support and the innermost end of said second core support is less than the length of said tubular core and ii) said first core support is received within said first open end of said tubular core and said second core support is received within said second open end of said tubular core.

19. The method of claim 18, further including applying a tension inhibiting rotation of the roll using a tensioner support on said frame that presses a pressure member against an interior of said core.

20. The method of claim 19, wherein said applying tension includes providing a manual tensioner that includes a) a handle member, b) a pressure member having a curved pressure surface configured to be received within the first open end of the core proximate said first core support, and c) a spring positioned to apply pressure against said pressure member upon movement of said handle.

21. The method of claim 20, wherein said handle member is a rotary member that is manually rotated.

22. The method of claim 21, wherein said spring is a coil spring that is compressed upon rotation of said rotary member.

23. The method of any of claims 18-22, wherein said expandable slit sheet material is an expandable slit sheet paper.

24. The method of claim 23, wherein said expandable slit sheet paper is an entirely recyclable paper.

25. The method of any of claims 18-22, wherein said core is made from paper, paperboard or cardboard.

26. The method of claim 25, wherein said core is entirely recyclable.

27. The method of claim 18, wherein said second core support is a ball member.

28. The method of any of claims 19-22, wherein said second core support is a ball member.

29. The method of claim 18, wherein said second core support is mounted on a member that is movably connected to said second support wall.

30. The method of any of claims 19-22, wherein said second core support is mounted on a member that is movably connected to said second support wall.

31. The method of any of claims 18-30, wherein said first core support has a curved support surface configured to contact an interior surface of said core, and wherein said second core support has a curved support surface configured to contact an interior surface of said core.

32. A system for manually expanding expandable slit sheet material, comprising:
a) a roll of expandable slit sheet material wound around a tubular core;
b) a manual dispenser having a frame including i) a first core support having a support surface that is configured to be received within a first open end of the tubular core and ii) a second core support having a support surface that is configured to be received within a second open end of the tubular core,
b) at least one of said first core support and said second core support being movably mounted on said frame such that a distance between the innermost end of said first core support and the innermost end of said second core support is changeable between a) a first position in which a distance between an innermost end of said first core support and an innermost end of said second core support is greater than a length of said tubular core whereby the roll of expandable material wound around the tubular core can be lowered upon said frame in between said innermost end of said first core support and said innermost end of said second core support and b) a second position in which the distance between the innermost end of said first core support and the innermost end of said second core support is less than a length of said tubular core and said first core support is received within said first open end of said tubular core and said second core support is received within said second open end of said tubular core.

33. The system of claim 32, wherein said first core support has a curved support surface configured to contact an interior surface of said core, and wherein said second core support has a curved support surface configured to contact an interior surface of said core.

34. The system of any of claims 32 to 33, further including a tensioner supported on said frame that presses a pressure member against an interior of said core.

35. The system of any of claims 32 to 33, further including a tensioner that includes a) a handle member, b) a pressure member having a curved pressure surface configured to be received within the first open end of the core proximate said first core support, and c) a spring positioned to apply pressure against said pressure member upon movement of said handle.

36. The system of claim 35, wherein said handle member is a rotary member that is manually rotated.

37. The system of claim 36, wherein said spring is a coil spring that is compressed upon rotation of said rotary member.

38. The system of any of claims 32-37, wherein said expandable slit sheet material is an expandable slit sheet paper.

39. The system of claim 38, wherein said expandable slit sheet paper is an entirely recyclable paper.

40. The system of any of claims 33-37, wherein said core is made from paper, paperboard or cardboard.

41. The system of claim 40, wherein said core is entirely recyclable.

42. The system of any of claims 33-37, wherein said second core support is a ball member.

43. The system of any of claims 33-37, wherein said second core support is mounted on a member that is movably connected to said second support wall.

44. A system for dispensing and manually expanding expandable slit sheet paper, comprising:
a roll of expandable slit sheet paper, said roll of expandable slit sheet paper being wound around a tubular core,
a frame having a first support wall,
a first core support fixedly attached to the first support wall and extending inwardly on an interior side of the first support wall, said first core support having a curved support surface that is configured to be received within a first open end of the core,
said first support wall having a tensioner including a) a handle member, b) a pressure member having a length that extends from an exterior of the tubular core into an interior of the tubular core, and c) a spring positioned to apply pressure against said pressure member upon movement of said handle member, and
said pressure member applying pressure upon a cylindrical interior surface of the tubular core via a curved pressure surface.

45. The system of claim 44, wherein said handle member is a rotated member.

46. The system of any of claims 44-45, wherein said tubular core has a length of between about 10 to 25 inches and wherein said curved pressure surface contacts the cylindrical interior surface of the tubular core between about ½ inch and 4 inches from an end of the tubular core.

47. The system of any of claims 44-46, wherein said curved pressure surface contacts the cylindrical interior surface of the tubular core between about 1 inch and 3 inches from an end of the tubular core.

48. The system of any of claims 44-47, wherein said tubular core has a length of between about 10 to 25 inches and said curved pressure surface contacts the cylindrical interior surface of the tubular core only within a range of between about ½ inch and 4 inches from an end of the tubular core.

49. The system of any of claims 44-48, wherein said curved pressure surface contacts the cylindrical interior surface of the tubular core only within a range of between about 1 inch and 3 inches from an end of the tubular core.

50. The system of any of claims 44-49, wherein said curved pressure surface is located beneath said curved support surface of said first core support.

51. The system of any of claims 44-50, wherein said curved pressure surface presses downloadly upon a bottom interior surface of the interior of the tubular core.

52. The system of any of claims 44-51, wherein said curved support surface extends entirely across the length of the tubular core.

53. The system of claim 52, wherein said curved support surface is a surface of a support shaft.

54. The system of any of claims 44-51, wherein said curved support surface extends partially across the length of the tubular core.

55. The system of claim 54, wherein said curved support surface extends between about ½ inch and 5 inches across the length of the tubular core.

56. The system of claim 55, wherein said curved support surface extends greater than 1 inch within the length of the tubular core.

57. The system of claim 55, wherein said curved support surface extends less than 4 inches within the length of the tubular core.

58. The system of any of claims 44-57, wherein said handle member is a rotary member that is manually rotated.

59. The system of claim 58, wherein said spring is a coil spring that is compressed upon rotation of said rotary member.

60. The system of any of claims 44-59, wherein said tubular core is made from paper, paperboard or cardboard.

61. The system of any of claims 44-60, wherein said curved pressure surface is a surface of said pressure member or an element directly or indirectly pressed by said pressure member.

62. The system of claim 61, wherein said curved pressure surface is a surface of said pressure member.

63. The system of any of claims 44-62, wherein said pressure member is a lever arm.

64. The system of claim 63, wherein said lever arm is a movable elongated member that extends from the exterior of the tubular core into the interior of the tubular core

65. The system of claim 63, wherein said lever arm is movable transverse to its length to apply a levered pressure force.

66. The system of any of claims 61-65, wherein said lever arm is reciprocated.

67. The system of claim 66, wherein said lever arm is reciprocated substantially linearly.

68. The system of any of claims 61-67, wherein said lever arm is reciprocated in a direction transverse to a length of the tubular core.

69. The system of any of claims 61-68, wherein said lever arm is reciprocated in a vertical direction

70. The system of any of claims 61-69, wherein said lever arm is reciprocated in a vertical direction on an exterior side of said support wall.

71. The system of any of claims 61-70, wherein said lever arm is reciprocated in a vertical direction on an exterior side of said support wall and on an interior side of said support wall.

72. The system of claim 71, wherein said lever arm is concurrently reciprocated in the same direction on the exterior side of said support wall and the interior side of said support wall.
